(19) United States
(12) Patent Application Publication
(10) Pub. No.: US 2022/0332932 A1
(43) Pub. Date: Oct. 20, 2022

(54) POLYOLEFIN-BASED VITRIMER MATERIALS CONTAINING DISULFIDE UNITS

(71) Applicant: SABIC Global Technologies B.V., Bergen op Zoom (NL)

(72) Inventors: Hendrik VERHOOGT, Geleen (NL); Jérôme VACHON, Geleen (NL); Jonathan TELLERS, Parma (IT)

(73) Assignee: SABIC Global Technologies B.V., Bergen op Zoom (NL)

(21) Appl. No.: 17/634,043

(22) PCT Filed: Aug. 18, 2020
(86) PCT No.: PCT/IB2020/057782

§ 371 Date: Feb. 9, 2022

Related U.S. Application Data
(60) Provisional application No. 62/888,660, filed on Aug. 19, 2019.

(51) Int. Cl. C08L 23/26; C08J 3/24; C08K 5/372

(52) U.S. Cl. CPC C08L 23/26; C08J 3/24; C08K 5/3725; C08J 2323/26

(57) ABSTRACT

Polyolefin based vitrimers having at least one disulfmyl linking unit are described. Uses and methods of making the vitrimers are also described.

### CROSS-REFERENCE TO RELATED APPLICATIONS

This application claims the benefit of priority of U.S. Provisional Patent Application No. 62/888,660 filed Aug. 19, 2019, which is hereby incorporated by reference in its entirety.

### GOVERNMENT STATEMENT

Some of the invention was made with support from the European Union's Horizon 2020 research and innovation program under the Marie Sklodowska-Curie grant agreement No 642929.

### BACKGROUND OF THE INVENTION

### A. Field of the Invention

The invention generally concerns a polyolefin based vitrimer that includes a sulfur based linking group attached to functionalized polyolefin based polymers.

### B. Description of Related Art

Vitrimers are an emerging class of polymers that have properties of permanently cross-linked thermosets while at the same time retaining processability due to covalently adaptable networks (CAN). CAN, when thermally triggered, can undergo exchange reactions of cross-links, which facilitate polymer network rearrangement, making macroscopic reshaping possible. If a stress is applied to the system, the cross-links can rearrange until the stress relaxes and a new shape is obtained. The relaxation process can be controlled by the reaction kinetics, and, consequently, the viscosity in the melt decreases following the Arrhenius law. This characteristic is distinctly different from conventional polymers such as polystyrene, which exhibits a viscosity drop abruptly after reaching its glass transition (Tg).

Various attempts to produce vitrimers have been described. By way of example, Japanese Patent Application Publication No. JP 2017202980 Hideyuki et al., describes a catalytic process to produce vitrimers having diamino disulfide linking units. The methodology to produce the linking units requires complex synthetic methodology. In addition, this methodology suffers in that the catalyst used in the process can leach into the final application, which can be detrimental to the final application.

While processes to prepare vitrimers have been described, many of them require catalysts and/or the resulting vitrimer is susceptible to hydrolysis and aging. There is therefore a need to develop stable vitrimer materials in a more cost efficient manner.

### SUMMARY OF THE INVENTION

A discovery has been made that address at least some of the problems associated with producing vitrimers. The solution is premised on using a sulfur-based linking unit with polyolefin based polymers. Without wishing to be bound by theory, it is believed that disulfide crosslinks undergo dynamic exchange reactions under the influence of light or heat and thus can be used in many applications (e.g., repair applications) and are versatile and easy to introduce into the polymer networks. The vitrimers of the present invention can have a semi-crystalline morphology and/or be recyclable.

In the context of the present invention, vitrimer materials that include sulfur-based units linked to functionalized polymeric units are described. Such a vitrimer can have the formula of A-L-A′ where A and A′ represent the same or different functionalized polymeric units and L can be the linking unit. The polymeric units (A, A′, or both) can be derived from a maleic anhydride-functionalized polyolefin or a glycidyl methacrylate-functionalized polyolefin, more preferably maleic anhydride-functionalized polypropylene or polyethylene, glycidyl methacrylate-functionalized polypropylene or polyethylene, or mixtures thereof. L can include at least two sulfur (S) atoms and have a formula of R¹—S¹—(S³)ₙ—S²—R² where n is 0 to 3 and R¹ and R² are each independently a substituted aliphatic group, or a substituted aromatic group, and R¹ and R² are each independently bonded to A or A′. R¹ and R² are attached to the functionalized portions of A and A′. For example, 1) a portion of R¹ can be attached to an anhydride portion of A and a portion of R² can be attached to an anhydride portion of A′ or vice versa, 2) a portion of R¹ can be attached to a glycidyl portion of A and a portion of R² can be attached to a glycidyl portion of A′ or vice versa, or 3) a portion of R¹ can be attached to an anhydride portion of A and a portion of R² can be attached to glycidyl portion, A′, or vice versa. More specifically, R¹ and R² can each independently include a terminal functional group such as an amine, a hydroxyl group, a carboxylic acid group, an ester, an ether, an amide, an imide, or combinations thereof capable of reacting with the functionalized portion of A and A′. For example, R¹ and R² can each independently include a terminal amine, a terminal hydroxyl group, a terminal carboxylic acid group, a terminal ester group, a terminal ether group, a terminal amide, or a terminal imide group. In another example, R¹ can include a terminal amine and R² can include a terminal hydroxyl group or vice versa, R¹ can include a terminal amine and R² a terminal carboxylic acid group or vice versa, or R¹ can include a terminal hydroxyl group, and R² a terminal carboxylic acid group or vice versa. The S¹ atom can be bonded to a carbon atom of the R¹ group and the S² atom can be bonded to a carbon atom of the R² group. In a preferred aspect, n is 0. R¹ and R² can each be independently a substituted aromatic group. In some embodiments, R¹ and R² are both an aniline group, L is a disulfanediyldianiline group and the vitrimer material can have the structure of:

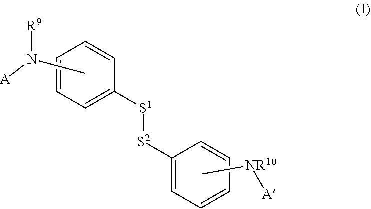

where R⁹ and R¹⁰ can each independently be a H, a alkyl group, or R⁹ can come together with functional group of A and form a ring, R¹⁰ can come together with functional group of A′ and form a ring, where A and A′ can be the same or different functionalized polymeric units. In some embodiments, the disulfanediyldianiline group is a 4,4′-disulfanediyldianiline group. In some embodiments, the disulfide is preferably 4,4′-disulfanediyldianiline group. In another instance, R¹ and R² can both be a benzoether group, L can be a disulfanediyl dibenzodiether group, and the vitrimer material can have the structure of:

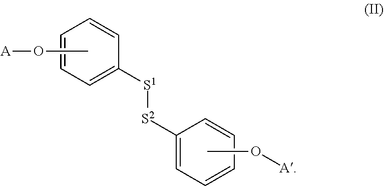

In some aspects, the disulfanediyl dibenzodiether group is preferably a 4,4′-disulfanediyl dibenzodiether. In yet another instance, R¹ and R² can both be a benzoester group, L can be a disulfanediyl dibenzodiester group and the vitrimer material can have the structure of:

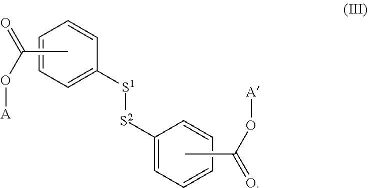

In some aspects, the disulfanediyl dibenzodiester group is preferably a 4,4′-disulfanediyl dibenzo diester group.

In some embodiments, R¹ and R² can each independently be a substituted aliphatic group. In some aspects, the substituted aliphatic group (e.g., R¹ and R²) can include a terminal carboxylic acid group and/or have the structure of:

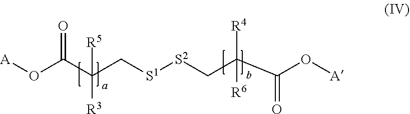

where a can be 0 to 10 and b can be 0 to 10, R³, R⁴, R⁵, and R⁶ can each independently be a hydrogen atom (H), an aliphatic group, a substituted aliphatic group, an aromatic group, a substituted aromatic group, or a heteroatom or a combination thereof, and A and A′ each represent the same or different polymeric units. Such vitrimers can have the structure of:

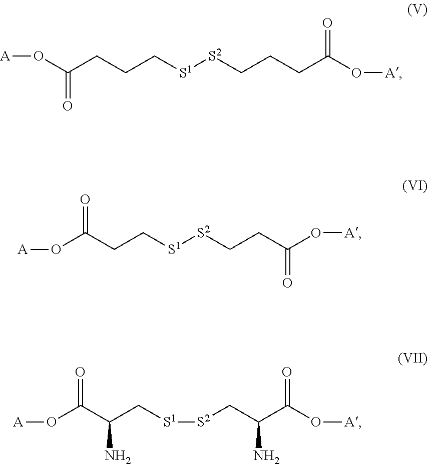

where A and A′ each independently represent the same or different functionalized polymeric units in each of the above structures. In some embodiments, the linking group includes a terminal hydroxyl group (e.g., R¹ and R² include a terminal hydroxyl group) and the linking group can have the following structure:

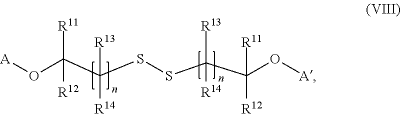

where R¹¹, R¹², R¹³, and R¹⁴ can each independently be a hydrogen atom (H), or a C₁ to C₁₀ aliphatic group, a C₁ to C₁₀ substituted aliphatic group, a C₆ to C₂₀ aromatic group, a C₆ to C₂₀ substituted aromatic group, or a heteroatom or a combination thereof, and n can be 0 to 20, and A and A′ each independently represent the same or different functionalized polymeric units. Such a vitrimer can have the following structure:

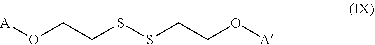

where A and A′ represent the same or different functionalized polymeric units.

In another aspect of the present invention processes to produce the vitrimers of the present invention are described. A process can include extruding a reactant mixture at a temperature of 120° C. to 300° C., preferably 140° C. to 210° C. The reactant mixture can include a functionalized polyolefin composition and a linking material having a formula of R¹—S—(S)ₙ—S—R² where n can be 0 to 3 and R¹ and R² can each independently be a substituted aliphatic group, or a substituted aromatic group, or a combination thereof. The functionalized polyolefin composition can include a maleic anhydride-functionalized polyolefin, a glycidyl methacrylate-functionalized polyolefin, or both. In a preferred instance, maleic anhydride functionalized polyethylene or polypropylene, or glycidyl methacrylate-functionalized polyethylene or polypropylene, or a combination thereof are used. A glycidyl methacrylate functionalized polyolefin can have the following structure:

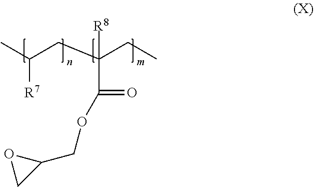

(X) where R⁷ and R⁸ can each independently be a H atom, an aliphatic group having 1 to 10 carbon atoms, a substituted aliphatic group having 1 to 10 carbon atoms, an aromatic group having 6 to 20 carbons, a substituted aromatic group having 6 to 20 carbons, where m and n are mole percentages with, n is 80 to 99.9 mol. %, and m is 0.1 to 20 mol. %, and m+n=100 mol. %. A maleic anhydride functionalized polyolefin can have a structure of

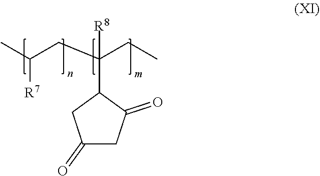

R⁷ and R⁸ can each independently be a H atom, an aliphatic group having 1 to 10 carbon atoms, a substituted aliphatic group having 1 to 10 carbon atoms, an aromatic group having 6 to 20 carbons, a substituted aromatic group having 6 to 20 carbons, wherein m and n are mole percentages with, n is 90 to 99.9 mol. %, m is 0.1 to 10 mol. %, and m+n=100 mol. %. Non-limiting examples of aliphatic groups can include methyl, ethyl, propyl, butyl, pentyl, hexyl, heptyl, octyl, nonyl, and decyl. The linking material can be at least one of: 4,4′-disulfanediyldianiline; 4,4′-disulfanediyldibenzoic acid; 4,4′-disulfanediyldiphenol; 3,3′-dithiodipropionic acid; 4,4′-dithiodibutyric acid; 2,2′-dithiodibenzoic acid; 2,2′-dithiodiethanol; or cystine. The linking material can include a terminal amino group, a terminal carboxylic group, a terminal hydroxyl group or a mixture thereof. Molar equivalents of such linking material to functionalized polyolefin can be 0.001 to 0.5, more preferable 0.01 to 0.5 molar equivalents, and most preferable 0.1 to 0.5 molar equivalents.

It is also contemplated in the context of the present invention that the vitrimer materials can be used to produce articles, sheets, films, and/or foams. The vitrimer materials can be used alone or in combination with other polymer material (e.g., blends) to produce such articles, sheets, films, and/or foams. Non-limiting examples of articles include land, air and sea vehicles, satellites, drilling equipment, large diameter pipes, reinforced thermoplastic pipes batteries, and the like. Non-limiting examples of land vehicle articles include, screws, engine brackets, seals, air intake manifolds, cam covers, crankshaft covers, fuel system, engine cooling shutters, oil pan, valve covers, motor covers, battery case and/or battery covers, tensioners, bumpers, panels, and the like. Exemplary reinforced thermoplastic pipes include but are not limited to multilayer reinforced thermoplastic pipes and the vitrimer materials can be included in one or more layers of the multilayer reinforced thermoplastic pipes. In some particular aspects, the multilayer reinforced thermoplastic pipe can contain an inner layer, a reinforced layer, and an outer layer and the vitrimer material can be included in the inner layer and/or other layers of the multilayer reinforced thermoplastic pipe. Other examples include electronic articles, including but not limited to computers, mobile phones, computer and television monitors. Such uses include without limitation chassis, circuit boards, molded products, wire and cable insulation, encapsulants, and adhesives and the like. Articles contemplated herein include, without limitation, any articles comprising the vitrimer materials of the present invention.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment discussed herein can be implemented with respect to any method or composition of the invention, and vice versa. Furthermore, compositions of the invention can be used to achieve methods of the invention.

The following includes definitions of various terms and phrases used throughout this specification.

An aliphatic group is an acyclic or cyclic, linear or branched, saturated or unsaturated carbon group, excluding aromatic compounds. A linear aliphatic group does not include tertiary or quaternary carbons. Non-limiting examples of aliphatic group substituents include halogen, hydroxyl, alkoxy, haloalkyl, haloalkoxy, carboxylic acid, ester, amine, amide, nitrile, acyl, thiol and thioether. A branched aliphatic group includes at least one tertiary and/or quaternary carbon. Non-limiting examples of branched aliphatic group substituents include alkyl, halogen, hydroxyl, alkoxy, haloalkyl, haloalkoxy, carboxylic acid, ester, amine, amide, nitrile, acyl, thiol and thioether. A cyclic aliphatic group is includes at least one ring in its structure. Polycyclic aliphatic groups may include fused, e.g., decalin, and/or spiro, e.g., spiro[5.5]undecane, polycyclic groups. Non-limiting examples of cyclic aliphatic group substituents include alkyl, halogen, hydroxyl, alkoxy, haloalkyl, haloalkoxy, carboxylic acid, ester, amine, amide, nitrile, acyl, thiol and thioether.

An alkyl group is linear or branched, substituted or unsubstituted, saturated hydrocarbon. Non-limiting examples of alkyl group substituents include alkyl, halogen, hydroxyl, alkoxy, haloalkyl, haloalkoxy, carboxylic acid, ester, amine, amide, nitrile, acyl, thiol and thioether. “Alkenyl” and “alkenylene” mean a monovalent or divalent, respectively, straight or branched chain hydrocarbon group having at least one carbon-carbon double bond (e.g., ethenyl (—HC═CH₂). “Alkynyl” means a straight or branched chain, monovalent hydrocarbon group having at least one carbon-carbon triple bond (e.g., ethynyl). “Alkoxy” means an alkyl group linked via an oxygen (i.e., alkyl-O—), for example methoxy. “Cycloalkyl” and “cycloalkylene” mean a monovalent and divalent cyclic hydrocarbon group, respectively, of the formula —CₙH₂ₙ₋ₓ and —CₙH₂ₙ₋₂ₓ— wherein x is the number of cyclizations.

An “aromatic” group is a substituted or unsubstituted, mono- or polycyclic hydrocarbon with alternating single and double bonds within each ring structure. Non-limiting examples of aryl group substituents include alkyl, halogen, hydroxyl, alkoxy, haloalkyl, haloalkoxy, carboxylic acid, ester, amine, amide, nitrile, acyl, thiol and thioether. Arylalkylene” means an alkylene group substituted with an aryl group (e.g., benzyl). The prefix “halo” means a group or compound including one or more halogen (F, Cl, Br, or I) substituents, which can be the same or different. The prefix “hetero” means a group or compound that includes at least one ring member that is a heteroatom (e.g., 1, 2, or 3 heteroatoms), wherein each heteroatom is independently N, O, S, or P. Aromatic groups include “heteroaryl” group or a “heteroaromatic” group, which is a mono- or polycyclic hydrocarbon with alternating single and double bonds within each ring structure, and at least one atom within at least one ring is not carbon. Non-limiting examples of heteroaryl group substituents include alkyl, halogen, hydroxyl, alkoxy, haloalkyl, haloalkoxy, carboxylic acid, ester, amine, amide, nitrile, acyl, thiol and thioether.

“Substituted” means that the compound or group is substituted with at least one (e.g., 1, 2, 3, or 4) substituents instead of hydrogen, where each substituent is independently nitro (—NO₂), cyano (—CN), hydroxyl (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g., benzyl), C₇₋₁₂ alkylarylene (e.g., toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the designated number of carbon atoms excluding the substituents.

The phrase “mechanical constraint” refers to the application of a mechanical force, locally or to all or part of the article such that the article's shape is transformed (e.g., deformed or formed). Non-limiting examples of mechanical constraints include pressure, molding, blending, extrusion, blow-molding, injection-molding, stamping, twisting, flexing, pulling, foaming and shearing.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 shows dynamic mechanical thermal analysis (DMTA) graphs for HDPE-MAH polyolefins cross-linked with 0, 0.25 and 0.5 equivalents of 4,4′-dithioaniline (DTA) with respect to the maleic anhydride group.

FIG. 2 shows frequency sweep at 160° C. of PE-MAH polyolefins cross-linked with 0, 0.25 and 0.5 equivalents of DTA (with respect to MAH groups).

FIG. 3 shows frequency sweep at 210° C. of LLDPE-MAH polyolefins cross-linked with 0 equivalents and 0.16 equivalents of DTA (with respect to MAH groups).

FIG. 4 shows complex viscosity determined at 210° C. of LLDPE-MAH polyolefins cross-linked with 0 equivalents and 0.16 equivalents of DTA (with respect to MAH groups).

FIG. 5 shows comparison of FTIR-spectra of HDPE-MAH (bottom line) and the HDPE-MAH polymer that was reacted with DTA (top line).

FIG. 6 shows frequency sweep at 210° C. of PE-GMA materials cross-linked with 0.05 equivalent of several dithio diacids and nonthio containing diacids (with respect to GMA groups).

FIG. 7 shows frequency sweep at 210° C. of PE-GMA materials cross-linked with 0.05 equivalents and 0.10 equivalents of dithiodibutanoic acid (DTDBA) with respect to GMA groups).

FIG. 8 shows complex viscosity determined at 210° C. of PE-GMA polymers cross-linked with 0.05 equivalents of diacid (with respect to GMA groups).

FIG. 9 shows complex viscosity determined at 210° C. of PE-GMA materials cross-linked with 0.05 equivalents and 0.10 equivalents of dithiodibutanoic acid (DTDBA) with respect to GMA groups).

FIGS. 10A-10C show comparison of FTIR-spectra of PE-GMA (black line), PE-GMA+0.05 EQ DTDBenA (dotted line) and PE-GMA+0.10 EQ DTDBenA (dashed line). FIG. 10 A shows the full spectrum in 600-1900 cm¹ range. FIG. 10 B shows the zoom-in in area of OH-signal. FIG. 10C shows a zoom-in in the area of the epoxy-signal.

FIG. 11 shows dynamic mechanical thermal analysis (DMTA) graphs for LLDPE-0.3 wt. % MAH polyolefins cross-linked with 0, 0.25 and 0.5 equivalents of 4,4′-dithioaniline (DTA) with respect to the maleic anhydride group.

FIG. 12 shows dynamic mechanical thermal analysis (DMTA) graphs for LLDPE-0.6 wt. % MAH polyolefins cross-linked with 0, 0.25 and 0.5 equivalents of 4,4′-dithioaniline (DTA) with respect to the maleic anhydride group.

FIG. 13 shows frequency sweep at 210° C. of LLDPE-0.6 wt. % MAH polyolefins cross-linked with 0, 0.25 and 0.5 equivalents of DTA (with respect to MAH groups).

FIG. 14 shows complex viscosity determined at 210° C. of LLDPE-0.6 wt. % MAH polyolefins cross-linked with 0, 0.25 and 0.5 equivalents of DTA (with respect to MAH groups).

### DETAILED DESCRIPTION OF THE INVENTION

A discovery has been made that address at least some of the problems associated with producing vitrimers. The solution is premised on using a sulfur based linking unit with polyolefin based polymers. The vitrimers of the present invention can have a semi-crystalline morphology and/or be recyclable.

These and other non-limiting aspects of the present invention are discussed in further detail in the following sections.

### A. Functionalized Polyolefin Based Polymers

The functionalized polyolefin based vitrimers of the present invention can include materials derived from functionalized polyolefins based polymers. Non-limiting examples of polyolefin based polymers can be polymers or copolymers derived from C₂₋₁₀ olefin monomeric materials. Non-limiting examples of C₂₋₁₀ olefin monomeric materials can include ethylene, propylene, butylene, pentene, hexene, heptene, octene, nonene, or decene, or mixtures thereof. Non-limiting examples of functional groups attached to the polyolefin based polymer include anhydrides such as maleic anhydride group, itaconic anhydride, alkyl acrylates and methacrylates such as methyl acrylate, ethyl acrylate, butyl acrylate, lauryl acrylate, methyl methacrylate, ethyl methacrylate, butyl methacrylate, and lauryl methacrylate; and ethylenically unsaturated oxiranes, such as glycidyl acrylate and glycidyl methacrylate. Preferred functional groups include maleic anhydride and/or glycidyl methacrylate. In one embodiment, the functionalized polyolefin based polymer is a maleic anhydride polyolefin based polymer. Such a polymer can have a structure of

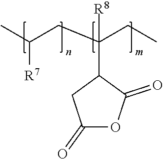

where R⁷ and R⁸ can each independently be a H atom, an aliphatic group having 1 to 10 carbon atoms, a substituted aliphatic group having 1 to 10 carbon atoms, an aromatic group having 6 to 20 carbons, a substituted aromatic group having 6 to 20 carbons, wherein m and n are mole percentage with, n is 90 to 99.9 mol. %, m is 0.1 to 10 mol. %, and m+n=100 mol. %. Non-limiting example of aliphatic groups can include methyl, ethyl, propyl, butyl, pentyl, hexyl, heptyl, octyl, nonyl, and decyl. In another embodiment, the functionalized polyolefin can be a glycidyl methacrylate polyolefin based polymer

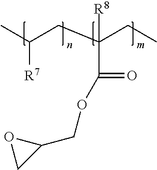

where R⁷ and R⁸ can each independently be a H atom, an aliphatic group having 1 to 10 carbon atoms, a substituted aliphatic group having 1 to 10 carbon atoms, an aromatic group having 6 to 20 carbons, a substituted aromatic group having 6 to 20 carbons, wherein m and n are mole percentages with, n is 80 to 99.9 mol. %, m is 0.1 to 20 mol. %, and m+n=100 mol. %. Non-limiting examples of aliphatic groups include methyl, ethyl, propyl, butyl, pentyl, hexyl, heptyl, octyl, nonyl, and decyl.

The functionalized polymers of the present invention can be made through a high-pressure free radical process, preferably a continuous process or a reactive extrusion process. In the high pressure process, suitable monomers can be polymerized under conditions to produce the functionalized polyolefins of the present invention. By way of example, a C₂₋₁₀ olefin material(s) and a (meth)acrylate material can be contacted with a polymerization initiator at conditions suitable to produce the functionalized polyolefins of the present invention. The flow of the reactants can be adjusted to control the degree of polymerization. Polymerization conditions can include temperature and pressures. Reaction temperatures can be at least any one of, equal to one of, or between any two of 100° C., 125° C., 150° C., 175° C., 200° C., 225° C., 250° C., 275° C., 300° C., 325° C. and 350° C. Reaction pressures can be at least any one of, equal to any one of, or between any two of 180 MPa, 190 MPa, 200 MPa, 210 MPa, 220 MPa, 230 MPa, 240 MPa, 250 MPa, 260 MPa, 270 MPa, 280 MPa, 290 MPa, 300 MPa, 310 MPa, 320 MPa, 330 MPa, 340 MPa and 350 MPa. Any peroxide polymer initiator can be used and are available from commercial vendors such as Arkema (France). Non-limiting examples of peroxide initiators include diacyl peroxide, t-butyl peroxypivalate or the like. In a reactive extrusion process, an olefinic polymer can be reacted in the melt with a peroxide to introduce radicals in the material that will enable the reaction of an anhydride with the olefin backbone. Typical temperatures used during the reactive extrusion process can be at least any one of, equal to one of, or between any two of 100° C., 125° C., 150° C., 175° C., 200° C., 225° C., 250° C., 275° C., 300° C., 325° C. and 350° C. Any peroxide polymer initiator can be used and are available from commercial vendors such as Arkema (France) or AKZO Nobel (The Netherlands). Non-limiting examples of peroxide initiators include diacyl peroxide, t-butyl peroxypivalate, or the like.

In some embodiments, high density polyethylene (HDPE), linear low density polyethylene (LLDPE), low density polyethylene (LDPE), polypropylene (PP) and polyolefin elastomers (POEs) can be used to prepare the functionalized polymeric units. HDPE, LLDPE, LDPE and POEs can have MFI-values (190° C./2.16 kg) of <0.01 to 200 g/10 min, 1.1 to 150 g/10 min, 1 to 100 g/10 min, 5 to 50 g/10 min, or at least one of, equal to one of, or between any two of 0.01, 0.1, 1, 5, 10, 20, 30, 40, 50, 60, 70, 80, 90 100, 150, and 200 g/10 min, measured in accordance with ISO 1133. PP can have MFI-values (230° C./2.16 kg) of <0.01 to 200 g/10 min, 1.1 to 150 g/10 min, 1 to 100 g/10 min, 5 to 50 g/10 min, or at least one of, equal to one of, or between any two of 0.01, 0.1, 1, 5, 10, 20, 30, 40, 50, 60, 70, 80, 90 100, 150, and 200 g/10 min measured in accordance with ISO 1133. In some embodiments, the MFI-value can be 5 to 10 g/10 min or any value there between at 190° C./2.16 kg measured in accordance with ISO 1133. After functionalization with a functional group (e.g., anhydride group, glycidyl methacrylate group) the MFI values can change. The levels of functionalization can be in the range of 0.1 to 10 wt. %, 1 to 5 wt. %, or at least one of, equal to one of, or between any two of 0.1, 1, 2, 3, 4, 5, 6, 7, 8, 9, and 10. In some embodiments the level of functionalization can be 1 to 2.5 wt. %. In another instance, polyethylene functionalized with glycidyl methacrylate (PE-GMA) can be used. For example, polyethylene functionalized with 1 to 10 wt. % (e.g., 1, 2, 3, 4, 5, 6, 7, 8, 9, 10 wt. %, and all values there between) GMA having a MFI-value (190° C./2.16 kg) of 1 to 10 g/10 min (e.g., 1, 2, 3, 4, 5, 6, 7, 8, 9, and 10 g/10 min, and all values in between) measured in accordance with ISO 1133. MFI values can be obtained using commercial melt flow instruments. Such instruments are made by Hanatek (UK), AML Instruments (UK), Göttfert (Germany) and the like. POs and POEs can be obtained from commercial suppliers such as SABIC (Saudi Arabia) and Arkema (France).

### B. Vitrimers

At least two polymeric units (e.g., A and A′) derived from the functionalized polyolefin based polymer of Section A can be linked with a linking moiety (L) to form a vitrimer of the formula A-L-A′. The linking group (L) can be sulfur based group having at least two sulfur atoms and is attached to the polymer through the functionalized group. L can have a formula of R¹—S¹—(S³)ₙ—S²—R² where n is 0 to 3 (e.g., 0, 1, 2, 3). In a preferred instance, n is zero. R¹ and R² can each independently be a substituted aliphatic group, or a substituted aromatic group, and R¹ can be bonded to A or A′ and R² can be bonded to A or A′. Specifically, S¹ can be bonded to a carbon atom of the R¹ group and R² can be bonded to a carbon atom of the S² group. R¹ and R² are each independently a substituted aliphatic group, or a substituted aromatic group, and R¹ and R² are each independently bonded to A and A′. More specifically, R¹ and R² are attached to the functionalized portion of A and A′ (e.g., anhydride portion, glycidyl portion, or the like). More specifically, R¹ and R² can each independently include a terminal functional group such as an amine, a hydroxyl group, a carboxylic acid group, an ester, an ether, an amide, an imide, or combinations thereof capable of reacting with the functionalized portion of each A. In a non-limiting example, R¹ and R² can each independently include a terminal amine, a terminal hydroxyl group, a terminal carboxylic acid group, a terminal ester, a terminal ether group, a terminal amide, or a terminal imide group. In another example, R¹ can include a terminal amine and R² can include a terminal hydroxyl group or vice versa, R¹ can include a terminal amine and R² a terminal carboxylic acid group or vice versa, or R¹ can be include a terminal hydroxyl group, and R² a terminal carboxylic acid group or vice versa. In one embodiment, R¹ and R² can each be a aniline group, a benzoether group, a benzoester group, a carboxylic acid group, a substituted carboxylic acid group, a diol, a substituted diol, or a combination thereof. In one embodiment, L can be a disulfanediyldianiline group (e.g., 4,4′-disulfanediyldianiline group), a disulfanediyl dibenzodiether group (e.g., 4,4′-disulfanediyl dibenzodiether group), a disulfanediyl dibenzodiester group (e.g., 4,4′-disulfanediyl dibenzodiester), a disulfanediyl dicarboxylic acid group, a substituted disulfanediyl dicarboxylic acid group, a disulfanediyl diol, a substituted disulfanediyl diol, or a combination thereof.

Non-limiting examples of vitrimers made using these disulfides are shown as structures:

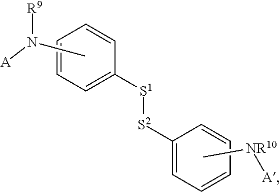

where R⁹ and R¹⁰ can each independently be a H, a alkyl group, or R⁹ can come together with functional group of A and form a ring, R¹⁰ can come together with functional group of A′ and form a ring, where A and A′ can be the same or different. In some embodiments, the disulfide is preferably 4,4′-disulfanediyldianiline group.

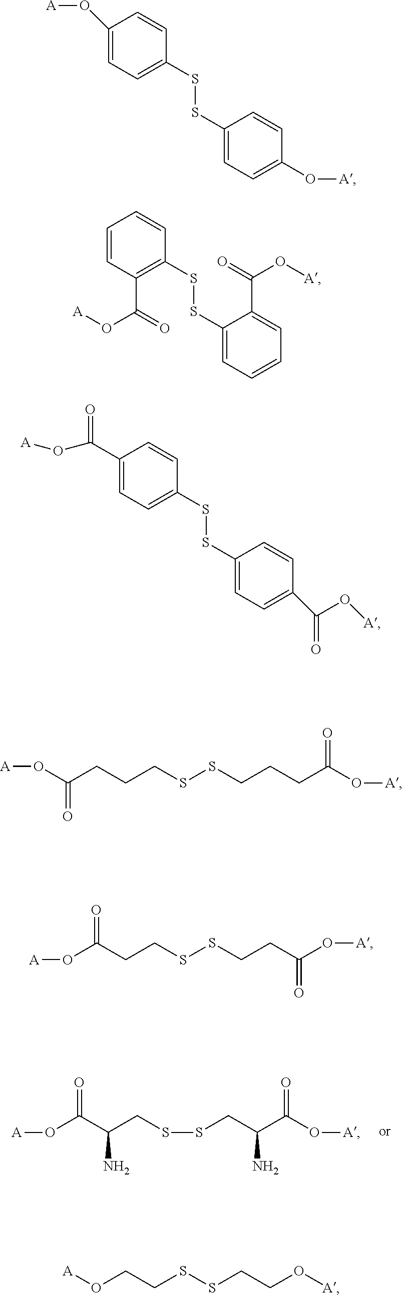

where A and A′ in each structure can be the same of different functionalized polyolefin based polymeric units. While not shown, it should be understood that the carbon atoms and amino groups in the above structures and in the specification can include one or more substituents.

In some instances, the vitrimer material can include the following polymeric vitrimeric material.

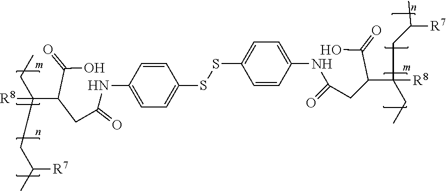

where R⁷ and R⁸ can each independently be H or methyl, wherein m and n are mole percentages with, n is 90 to 99.9 mol. %, m is 0.1 to 10 mol. %, and m+n=100 mol. %, and/or

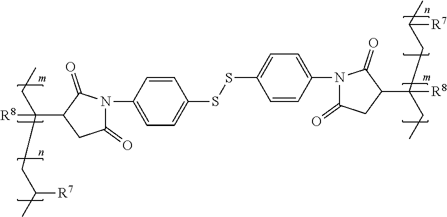

where R⁷ and R⁸ can each independently be H or methyl, wherein m and n are mole percentages with, n is 90 to 99.9 mol. %, m is 0.1 to 10 mol. %, and m+n=100 mol. %. In some embodiments,

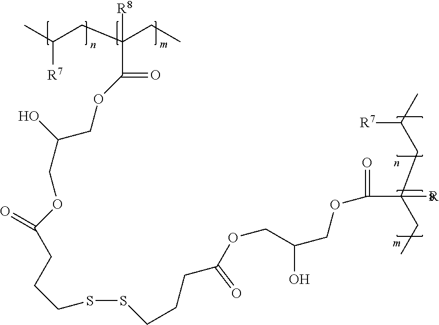

where R⁷ and R⁸ can each independently be H or methyl, where m and n are mole percentages with, n is 80 to 99.9 mol. %, and m is 0.1 to 20 mol. %, and m+n=100 mol. %. While the vitrimers are shown as having a functionalized polyethylene structure, it should be understood that the polyolefin portion can be any polyolefin or polyolefins described herein (e.g., polyethylene, polypropylene, copolymer of ethylene and octene, and the like).

Vitrimers of the present invention can be produced through a condensation reaction of the linking group with the functionalized polyolefin. The vitrimers can be manufactured by various methods known in the art. By way of example, the vitrimers can be produced using an extrusion process. The functionalized polymer (malic anhydride functionalized polyolefin or glycidyl methacrylate functionalized polyolefin) can be contacted with an amount of linking material (e.g., a disulfide, 4,4′-disulfanediyldianiline, 4,4′-disulfanediyldibenzoic acid, 4,4′-disulfanediyldiphenol, 3,3′-dithiodipropionic acid, 4,4′-dithiodibutyric acid, 2,2′-dithiodibenzoic acid, 2,2′-dithiodiethanol, or cystine, or mixtures thereof) under conditions sufficient to react the linking material with the functionalized polymer (e.g., anhydride, epoxide, etc.) to form the vitrimer. The amount of linking agent (e.g., bifunctional disulfide having amine, carboxylic, hydroxyl, ether, amide or imide terminal groups, or mixtures thereof) can be 0.001 to 0.5 molar equivalents, or at least one of, equal to one of, or between any two of 0.001, 0.005, 0.01, 0.05, 0.1, and 0.5 molar equivalents compared to the functionalized polyolefin. In one instance, 0.01 to 0.5 molar equivalents of linking agent (e.g., bi-functional di-sulfide moiety) to functionalized polyolefin can be used. In another instance, 0.1 to 0.5 molar equivalents of linking agent to functionalized polyolefin can be used. In some instances, the functionalized polymer and linking material can be blended in a high speed mixer or by hand mixing. The blend is then fed into the throat of a twin-screw extruder via a hopper. Alternatively, the linking material can be contacted with the functionalized polymer by feeding it directly into the extruder at the throat or downstream through a side port into the extruder. The extruder is generally operated at a temperature higher than that necessary to cause the functionalized polyolefin to flow and sufficient to promote the condensation reaction. Reaction conditions can include temperatures from 120° C. to 300° C., preferably 140° C. to 210° C., or at least any one of, equal to any one of, or between any two of 120° C., 130° C., 140° C., 150° C., 160° C., 170° C., 180° C., 190° C., 200° C., 210° C., 220° C., 230° C., 240° C., 250° C., 260° C., 270° C., 280° C., 290° C. and 300° C. The extrudates can be immediately quenched in a water bath and pelletized. Such pellets can be used for subsequent molding, shaping, or forming. A non-limiting example of preparation of a disulfide based vitrimer material is shown in the following reaction scheme where n and m are as defined above.

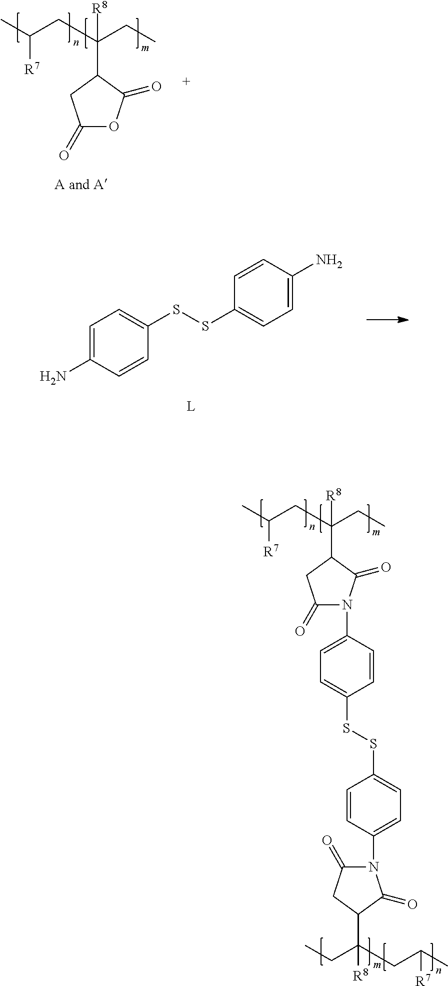

The vitrimers of the present invention can be produced as articles, films, sheets, foams, particles, granules, beads, rods, plates, strips, stems, tubes, etc. via any process known to those skilled in the art. By way of example, extrusion, casting, compression molding can be used. These elemental components based on the vitrimers of the present invention, are easy to store, transport and handle.

The components can be subjected to heat and/or mechanical constraint through blending, extrusion, molding (injection or extrusion), blow-molding, foaming or thermoforming to form an article of manufacture. This transformation can include mixing or agglomeration with one or more additional components chosen from: one or more polymers, pigments, dyes, fillers, plasticizers, fibers, flame retardants, antioxidants, lubricants.

### C. Articles of Manufacture

The vitrimers of the present invention can be used in all types of applications and articles of manufacture. Non-limiting examples of the types of applications that the materials of the present invention can be used in include motor vehicles, airplanes, boats, aeronautical construction or equipment or material, electronics, sports equipment, construction equipment and/or materials, printing, packaging, biomedical, and cosmetics.

Certain embodiments are directed to an article of manufacture containing a vitrimer described herein. The vitrimer can form a major part (e.g. the article can be mostly made of the vitrimer), a substantial part, a minor part, or a very minor part (e.g. only a small part of the article can be made of the vitrimer) of the article of manufacture. Non-limiting examples of articles of manufacture can include vehicle (e.g., land, air and sea vehicles), vehicle parts, batteries, electronic device (e.g., device housings or components for computers, laptops, phones, tablets, batteries, wireless charging, AR/VR goggles, etc.), electrical device, leak tight seals, thermal or acoustic insulators, tires, cables, sheaths, footwear soles, packagings, multilayer articles, coatings (e.g., paints, films, cosmetic products), patches (e.g., cosmetic or dermopharmaceutical), furniture, foams, systems for trapping and releasing active agents, dressings, elastic clamp collars, vacuum pipes, reinforced thermoplastic pipes (e.g. multilayer reinforced thermoplastic pipes) or pipes and flexible tubing for the transportation of fluids. Examples of vehicle parts include plastic engine brackets seals, air intake manifolds, cam covers, crankshaft covers, fuel system, engine cooling shutters, oil pan parts, valve covers, motor covers, battery case and/or battery covers, tensioners, bumpers, panels, exterior automobile components (grill, mirror, housing, pillar, spoiler, logo, roof rail, bezel, trim, fender, etc.), interior automobile components (decorative parts, electronic housings, instrument panel components, navigation system, housing frames, etc.) and the like. Examples of packaging materials include films and/or pouches, especially for applications such as food and/or beverage packaging applications, for health care applications, and/or pharmaceutical applications, and/or medical or biomedical applications. Exemplary multilayer articles include but are not limited to a cap-layer in sheet, a top-layer or an intermediate layer in a multi-layer assembly (e.g., for electronics, photovoltaics, (O)LED), film for insert molding or in-mold decoration, top-layer for composite, etc.).

In some aspects the article can be an automotive bumper, an automotive exterior component, an automobile mirror housing, an automobile wheel cover, an automobile instrument panel or trim, an automobile glove box, an automobile door hardware or other interior trim, an automobile exterior light, an automobile part within the engine compartment, an agricultural tractor or device part, a window or a component thereof, a construction equipment vehicle or device part, a marine or personal water craft part, an all-terrain vehicle or all-terrain vehicle part, plumbing equipment, a valve or pump, an air conditioning heating or cooling part, a furnace or heat pump part, a computer housing, a computer housing or business machine housing or part, a housing or part for monitors, a computer router, a desk top printer, a large office/industrial printer, an electronics part, a projector part, an electronic display part, a copier part, a scanner part, an electronic printer toner cartridge, a handheld electronic device housing, a housing for a hand-held device, a hair drier, an iron, a coffee maker, a toaster, a washing machine or washing machine part, a microwave, an oven, a power tool, an electric component, an electric enclosure, a lighting part, a component for a lighting fixture, a dental instrument, a medical instrument, a medical or dental lighting part, an aircraft part, a train or rail part, a seating component, a sidewall, a ceiling part, cookware, a medical instrument tray, an animal cage, fibers, a laser welded medical device, fiber optics, a lens (auto and non-auto), a cell phone part, a greenhouse component, a sun room component, a fire helmet, a safety shield, safety glasses, a gas pump part, a humidifier housing, a thermostat control housing, an air conditioner drain pan, an outdoor cabinet, a telecom enclosure or infrastructure, a Simple Network Detection System (SNIDS) device, a network interface device, a smoke detector, a component or device in a plenum space, a medical scanner, X-ray equipment, a component for a medical application or a device, an electrical box or enclosure, and an electrical connector, a construction or agricultural equipment, and a turbine blade.

In further aspects the article is a component of an aircraft interior or a train interior, an access panel, access door, air flow regulator, air gasper, air grille, arm rest, baggage storage door, balcony component, cabinet wall, ceiling panel, door pull, door handle, duct housing, enclosure for an electronic device, equipment housing, equipment panel, floor panel, food cart, food tray, galley surface, handle, housing for television, light panel, magazine rack, telephone housing, partition, part for trolley cart, seat back, seat component, railing component, seat housing, shelve, side wall, speaker housing, storage compartment, storage housing, toilet seat, tray table, tray, trim panel, window molding, window slide, a balcony component, baluster, ceiling panel, cover for a life vest, cover for a storage bin, dust cover for a window, layer of an electrochromic device, lens for a television, electronic display, gauge, or instrument panel, light cover, light diffuser, light tube, light pipes, mirror, partition, railing, refrigerator door, shower door, sink bowl, trolley cart container, trolley cart side panel, or window. In some aspects, the article of manufacture can be a land, air or sea vehicle.

The materials can be in direct contact with an item intended for human or animal use, such as for example a beverage, a food item, a medicine, an implant, a patch or another item for nutritional and/or medical or biomedical use. The articles of manufacture can exhibit good resistance to tearing and/or to fatigue. The articles of manufacture can include rheological additives or additives for adhesives and hot-melt adhesives. In these applications, the materials according to the invention can be used as such or in single-phase or multiphase mixtures with one or more compounds such as petroleum fractions, solvents, inorganic and organic fillers, plasticizers, tackifying resins, antioxidants, pigments and/or dyes, for example in emulsions, suspensions or solutions. In some aspects, the article of manufacture can contain a solid component, a polymeric material, a film, a sheet, or a foam, containing the vitrimer.

In an embodiment, an article based on the vitrimers of the present invention can be manufactured by molding, filament winding, continuous molding or film-insert molding, infusion, pultrusion, RTM (resin transfer molding), RIM (reaction-injection molding), 3D printing, or any other method known to those skilled in the art. The means for manufacturing such an article are well known to those skilled in the art. In some embodiments, the vitrimers of the present invention and/or other ingredients can be mixed and introduced into a mold and the temperature raised.

Films that include the vitrimers of the present invention can have various thicknesses. For example, films can be from 1 micrometer to 1 mm thick. Multilayer films of the present invention can be produced by co-extrusion or other bonding methodology.

In some embodiments, the vitrimers of the present invention, on account of their particular composition, can be transformed, repaired, and/or recycled by raising the temperature of the article. Below the glass transition (Tg) temperature, the vitrimers are vitreous-like and/or have the behavior of a rigid solid body. Above the Tg temperature (or Tm for semi-crystalline polymers), the vitrimers become flowable and moldable. Below the Tg or the solidification temperature, in case of semi-crystalline materials, the material behaves like a hard glassy solid, whereas above, the material is soft and rubber like. The other temperature of importance is related to the exchange reactions of the vitrimer network called the topology freezing temperature (Tv). Until exchange reactions become fast enough, the network is set, and the topology cannot change. The convention is to place Tv at the solid to liquid transition point where a viscosity of 10¹² Pa·s is reached. The vitrimer will first behave like a glassy solid below Tg in case of amorphous materials, then like an elastomer above Tg, and finally, when Tv is reached, the viscosity will decline following the Arrhenius law because viscosity is predominantly controlled by the exchange reactions. For semi-crystalline polymers, also the melting temperature (Tm) and the crystallization temperature (Tc) has to be considered. For sufficiently crystalline polymers (crystalline network leading to elastic network response), Tm/Tc will have a similar influence as Tg, below which the topology is frozen due to the physical connections provided by the crystals inhibiting flow and therefore the ability to measure Tv.

Transforming at least one article made from a vitrimer of the present invention can include application to the article of a mechanical constraint at a temperature (T) above the Tm of the material. The mechanical constraint and temperature are selected to enable transformation within a time that is compatible with industrial application of the process. By way of example, a transformation can include applying a mechanical constraint at a temperature (T) above the Tm of the material of which the article is composed, and then cooling to room temperature, optionally with application of at least one mechanical constraint. By way of example, an article of manufacture such as a strip of material can be subjected to a twisting action. In another example, pressure can be applied using a plate or a mold onto one or more faces of an article of the invention. Pressure can also be exerted in parallel onto two articles made of material in contact with each other so as to bring about bonding of these articles. In yet another example, a pattern can be stamped in a plate or sheet made of material of the invention. The mechanical constraint may also consist of a plurality of separate constraints, of identical or different nature, applied simultaneously or successively to all or part of the article or in a localized manner. Raising of the temperature of the article or manufacture or of any vitrimer of the present invention can be performed by any known means such as heating by conduction, convection, induction, spot heating, infrared, microwave or radiant heating. The means for bringing about an increase in temperature can include an oven, a microwave oven, a heating resistance, a flame, an exothermic chemical reaction, a laser beam, a hot iron, a hot-air gun, an ultra-sonication tank, a heating punch, etc. In some embodiments, application of a sufficient temperature and a mechanical constraint to an article of manufacture that includes a vitrimer of the present invention, a crack or damage caused in a component formed from the material or in a coating based on the material can be repaired.

In some embodiments, an article made of vitrimer material of the invention may also be recycled, for example, by direct treatment of the article or by size reduction. For example, the broken or damaged article of manufacture can be repaired by means of a transformation process as described above and can thus regain its prior working function or another function. In another example, the article of manufacture can be reduced to particles by application of mechanical grinding, and the particles thus obtained can then be used in a process for manufacturing an article. In some embodiments, the reduced particles can be simultaneously subjected to a raising of temperature and a mechanical constraint; allowing them to be transformed into an article. The mechanical constraint that allows the transformation of particles into an article can include compression molding, blending or extrusion. Thus, molded articles can be made from the recycled material that includes the vitrimers of the present invention.

In some embodiments, transforming the components or articles of manufacture can be performed by a final user without chemical equipment (no toxicity or expiry date or VOC, and no weighing out of reagents).

In the context of the present invention, at least the following 23 embodiments are shown. Embodiment 1 is directed to a vitrimer material having a formula of A-L-A′, wherein A and A′ are each independently a functionalized polymeric unit and L is a linking unit comprising at least two sulfur (S) atoms and having a formula of R¹—S¹—(S³)ₙ—S²—R² where n is 0 to 3 and R¹ and R² are each independently a substituted aliphatic group, or a substituted aromatic group, and R¹ and R² are each independently bonded to A or A′.

Embodiment 2 is directed to the vitrimer material of embodiment 1, wherein the S¹ atom is bonded to a carbon atom of the R¹ group and the S² atom is bonded to a carbon atom of the R² group.

Embodiment 3 is directed to the vitrimer material of any one of embodiments 1 to 2, wherein n is 0.

Embodiment 4 is directed to the vitrimer material of any one of embodiments 1 to 3, wherein R¹ and R² are each independently a substituted aromatic group.

Embodiment 5 is directed to the vitrimer material of embodiment 4, wherein R¹ and R² are both an aniline group, and the vitrimer material has the structure of:

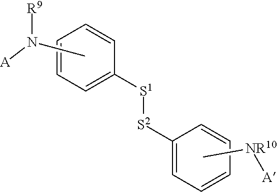

where A and A′ can be the same or different functionalized polymeric units, R⁹ and R¹⁰ can each independently be a H, an alkyl group, or R⁹ can come together with functional group of A and form a ring, and R¹⁰ can come together with functional group of A′ and form a ring.

Embodiment 6 is directed to the vitrimer material of embodiment 4, wherein R¹ and R² are both a benzoether group, and the vitrimer material has the structure of:

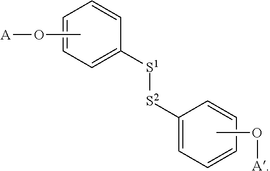

Embodiment 7 is directed to the vitrimer material of embodiment 4, wherein R¹ and R² are both a benzoester group, and the vitrimer material has the structure of:

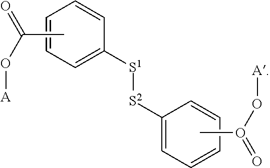

Embodiment 8 is directed to the vitrimer material of any one of embodiments 1 to 3, wherein R¹ and R² are each independently a substituted aliphatic group.

Embodiment 9 is directed to the vitrimer material of embodiment 8, wherein the substituted aliphatic group comprises a carboxylic acid group.

Embodiment 10 is directed to the vitrimer material of embodiment 9, wherein the vitrimer has the structure of:

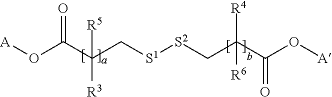

where a is 0 to 10 and b is 0 to 10, R³, R⁴, R⁵, and R⁶ are each independently a hydrogen atom (H), an aliphatic group, a substituted aliphatic group, an aromatic group, a substituted aromatic group, or a heteroatom or a combination thereof, and A and A′ represent the functionalized polymeric units.

Embodiment 11 is directed to the vitrimer material of embodiment 10, wherein the vitrimer has the structure of.

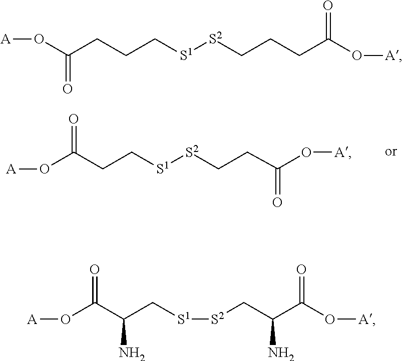

where A represents the polymeric unit.

Embodiment 12 is directed to the vitrimer material of embodiment 8, wherein the substituted aliphatic group comprises a hydroxyl group and/or the vitrimer has the structure of:

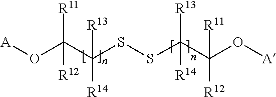

where R¹¹, R¹², R¹³, and R¹⁴ can each independently be a hydrogen atom (H), or a C₁ to C₁₀ aliphatic group, a substituted C₁ to C₁₀ aliphatic group, a C₆ to C₂₀ aromatic group, a substituted C₆ to C₂₀ aromatic group, or a heteroatom or a combination thereof, and n can be 0 to 20, and A and A′ represent the functionalized polymeric units.

Embodiment 13 is directed to the vitrimer material of embodiment 12, wherein the vitrimer has the structure of

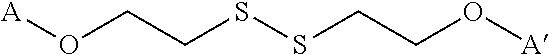

where A and A′ represent the functionalized polymeric units.

Embodiment 14 is directed to the vitrimer material of any one of embodiments 1 to 13, wherein the polymeric unit A, A′, or both are derived from a maleic anhydride-functionalized polyolefin based polymer or a glycidyl methacrylate-functionalized polyolefin based polymer.

Embodiment 15 is directed to the vitrimer material of any one of embodiments 1 to 14, wherein the vitrimer comprises a semi-crystalline morphology and/or is recyclable.

Embodiment 16 is directed to a polymeric material comprising the vitrimer of any one of embodiments 1 to 15, wherein the polymeric material is preferably in the form of an article, a film, a sheet, or a foam, preferably an article, more preferably a land, sea, or air vehicle

Embodiment 17 is directed to a process of producing the vitrimer material of any one of embodiments 1 to 16, the process comprising extruding a reactant mixture at a temperature of 120° C. to 300° C., preferably 140° C. to 210° C., wherein the reactant mixture comprises a functionalized polyolefin composition and a linking material having a formula of R¹—S—(S)ₙ—S—R² where n is 0 to 3 and R¹ and R² are each independently a substituted aliphatic group, or a substituted aromatic group, or a combination thereof.

Embodiment 18 is directed to the process of embodiment 17, wherein the functionalized polyolefin composition comprises a maleic anhydride-functionalized polyolefin, a glycidyl methacrylate-functionalized polyolefin, or both, preferably maleic anhydride functionalized polyethylene, glycidyl methacrylate-functionalized polyethylene, or both, most preferably

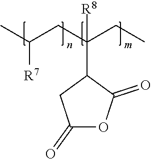

where R⁷ and R⁸ are each independently a H atom, an aliphatic group or a substituted aliphatic group having 1 to 10 carbon atoms, or an aromatic group or a substituted aromatic group having 6 to 20 carbon atoms, wherein m and n are mole percentages with, n is 90 to 99.9 mol. %, m is 0.1 to 10 mol. %, and m+n=100 mol. %; and/or

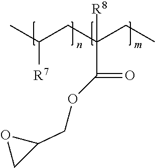

where R⁷ and R⁸ are each independently a H atom, an aliphatic group or a substituted aliphatic group having 1 to 10 carbon atoms, or an aromatic group or a substituted aromatic group having 6 to 20 carbon atoms, wherein m and n are mole percentages with, n is 80 to 99.9 mol. %, and m is 0.1 to 20 mol. %, and m+n=100 mol. %.

Embodiment 19 is directed to the process of any one of embodiments 17 to 18, wherein the linking material comprises an terminal amino group, a terminal carboxylic group, a terminal hydroxyl group or a mixture thereof, preferably, the linking material is at least one of: 4,4′-disulfanediyldianiline; 4,4′-disulfanediyldibenzoic acid; 4,4′-disulfanediyldiphenol; 3,3′-dithiodipropionic acid; 4,4′-dithiodibutyric acid; 2,2′-dithiodibenzoic acid; 2,2′-dithiodiethanol; or cystine.

Embodiment 20 is directed to the process of any one of embodiments 17 to 19, wherein the linking material comprises an terminal amino group, a terminal carboxylic group, a terminal hydroxyl group or a mixture thereof, and wherein a molar equivalents of linking material to functionalized polyolefin is 0.001 to 0.5, more preferable 0.01 to 0.5 molar equivalents, and most preferable 0.1 to 0.5 molar equivalents.

Embodiment 21 is directed to an article of manufacture containing the vitrimer of any one of embodiments 1 to 15.

Embodiment 22 is directed to the article of embodiment 21, wherein said article contains a solid component, a polymeric material, a film, a sheet, or a foam containing the vitrimer of any one of embodiments 1 to 15.

Embodiment 23 is directed to the article of embodiment 21 or 22, wherein said article is a vehicle or a vehicle component.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

The HDPE and LLDPE (both SABIC) have MFI-values (190° C./2.16 kg) of 8 g/10 min and 4.2 g/10 min, respectively. After functionalization with maleic anhydride (2.5 wt. % as determined with NMR) the measured MFI-values are 3.3 g/10 min and 4.7 g/10 min, respectively, for the HDPE and LLDPE-functionalized polymers. Two MAH-functionalized polyolefin elastomers (POE) (obtained from Yparex) were used, having an MFI-value of 4.2 g/10 min and 1.14 wt. % MAH (POE1-MAH), and a MFI-value of 0.9 g/10 min and 1.32 wt. % MAH (POE2-MAH), respectively. Lotader AX8840, a polyethylene functionalized with glycidyl methacrylate (PE-GMA) (Arkema), contained 8 wt. % GMA and has a MFI-value of 5 g/10 min (190° C./2.16 kg). MFI-values were measured in accordance with ISO 1133.

As di-sulfide containing moieties were used 4,4′-disulfanediyldianiline, 4,4′-disulfanediyldibenzoic acid, 4,4′-disulfanediyldiphenol, 3,3′-dithiodipropionic acid, 4,4′-dithiodibutyric acid, 2,2′-dithiodibenzoic acid, and 2,2′-dithiodiethanol. Dodecanedioic acid was used as a comparative cross-linking agent. All dithio and non dithio crosslinking agents were obtained from SigmaMillipore (USA).

### Example 1

### Preparation of Polyethylene-Maleic Anhydride Disulfide Vitrimers Using Molten Compounding

High density (HD) PE-MAH disulfide vitrimers were prepared using the following procedure: The polymer was molten at 140° C. inside a Haake™ PolyLab™ compounding machine until the observed torque was constant. Then, the machine was opened and a desired molar equivalent amount of 4,4′-dithiodianiline (DTA) with respect to MAH groups was added to the molten polymer. The machine was closed and the polymer melt was allowed to react for 15 min or until the observed torque became constant. The screws were stopped, the machine opened, and the hot material was removed and collected. Table 1 lists the equivalent amount of DTA and the mol % of MAH in the HDPE-MAH polymer.

TABLE 1

| | | MAH (mol %) | | Molar Equivalent |
|---|---|---|---|---|
| Entry | Material | in polymer | Amine | of DTA |
| 1-1 | HDPE-MAH | 0.4 | None | 0 |
| 1-2 | HDPE-MAH | 0.4 | DTA | 0.5 |
| 1-3 | HDPE-MAH | 0.4 | DTA | 0.25 |

### Example 2

### Preparation of Polyolefin (PO)-MAH Disulfide Vitrimers Using Dry Blend Mixing Followed By Melt Extrusion Compounding

A dry blend of maleic anhydride functionalized polyolefin (PO-MAH) polymer powder (10 gram) and DTA was prepared by mixing the required amount of PO-MAH polymer powder and a molar equivalent amount of the dithio moiety (with respect to MAH-groups). This dry blend was fed into a DSM Explore Mini Compounding Unit (MCU) in small steps to ensure that the torque did not reach the maximum level of the machine. Blending of the materials was continued until the torque was constant or for about 5 minutes after all material was loaded into the mini-extruder. Higher loadings of DTA as the dithio moiety (=higher equimolar levels) resulted in exceeding the maximum torque of the machine. Table 2 lists an overview of PO-MAH-based materials and dithio moieties.

TABLE 2

| | | | mmol MAH | Molar |
|---|---|---|---|---|
| | Functionalized | MAH (wt. %) | (in 10 gram | Equivalent |
| Entry | polyolefin | in polymer | polymer) | of DTA |
| 2-1-0 | HDPE-MAH | 2.5 | ≈2.55 | 0.0 |
| 2-1-1 | HDPE-MAH | 2.5 | ≈2.55 | 0.17 |
| 2-2-0 | LLDPE-MAH | 2.5 | ≈2.55 | 0.0 |
| 2-2-1 | LLDPE-MAH | 2.5 | ≈2.55 | 0.16 |
| 2-3-0 | POE1-MAH | 1.14 | ≈1.16 | 0.0 |
| 2-3-1 | POE1-MAH | 1.14 | ≈1.16 | 0.1 |
| 2-3-2 | POE1-MAH | 1.14 | ≈1.16 | 0.2 |
| 2-3-3 | POE1-MAH | 1.14 | ≈1.16 | 0.4 |
| 2-4-0 | POE2-MAH | 1.38 | ≈1.35 | 0.0 |
| 2-4-1 | POE2-MAH | 1.38 | ≈1.35 | 0.20 |

POE1-MAH and POE2-MAH are copolymers of ethylene and octene functionalized with malic anhydride.

### Example 3

### Preparation of PE-Glycidyl methacrylate (GMA) Vitrimers Using Various Dithio Moieties

PE-GMA disulfide vitrimers were prepared using the following procedure. A dry blend of PE-GMA polymer powder (containing 8 wt. % GMA) and disulfide moiety was prepared by mixing the required amount of polymer powder and an equivalent amount of the dithio diacid or a diacid hydrocarbon reference moiety (with respect to GMA-groups). This dry blend was fed into the DSM Explore MCU using a small screw-driven feeder. After all material was loaded into the mini-extruder blending of the materials was continued at 210° C. until the torque was constant. Table 3 lists the types and amounts of dithio moieties used.

TABLE 3

| | | | mmol GMA (in 10 | Molar Equivalent |
|---|---|---|---|---|
| Entry | Polymer | Crosslinker | gram polymer) | of Diacid |
| 3-0 | PE-GMA | — | ≈5.63 | — |
| 3-1-1 | PE-GMA | DTDPA | ≈5.63 | 0.05 |
| 3-1-2 | PE-GMA | | ≈5.63 | 0.10 |
| 3-2-1 | PE-GMA | DTDBA | ≈5.63 | 0.05 |
| 3-2-2 | PE-GMA | | ≈5.63 | 0.10 |
| 3-3-1 | PE-GMA | DTDBenA | ≈5.63 | 0.05 |
| 3-3-2 | PE-GMA | | ≈5.63 | 0.10 |
| 3-4-1 | PE-GMA | DDDA | ≈5.63 | 0.05 |
| 3-4-2 | PE-GMA | | ≈5.63 | 0.10 |

DTDPA = 3,3′-dithiodipropionic acid
DTDBA = 4,4′-dithiodibutyric acid
DTDBenA = 2,2′-dithiodibenzoic acid
DDDA = dodecanedioic acid, reference crosslinking material.

### Example 4

### Testing Methodology

Dynamic Mechanical Thermal Analysis (DMTA) Measurements. Rectangular samples suitable for DMTA were cut to dimension of 3×5×0.5 mm (length×width×thickness) from a film that was obtained via compression molding. Samples were measured on a TA Instruments Q800 in tensile mode. The storage modulus (E′) and loss modulus (E″) were monitored while screening the samples during a temperature sweep from −100 to 200° C. at 3° K/min. An oscillation frequency of 1 Hz with an oscillation amplitude of 10 μm was applied.

Rheology. Samples for rheology were prepared via compression molding to obtain disk shaped specimens (diameter 25 mm, thickness 1 mm). Samples were measured using a TA Instruments DHR-2, equipped with a parallel plate geometry, or an Anton Paar MCR502, equipped with a parallel plate geometry. Frequency sweep measurements were made in the frequency range from 100-0.01 rad/s using a strain amplitude of 0.4% at a temperature of 160° C., or a strain amplitude of 1% at a temperature of 210° C. Stress relaxation measurements were conducted at 210° C. by applying a constant shear strain of 1%.

### Example 5

### Analysis of Examples 1-3 Vitrimers and Reference Compounds

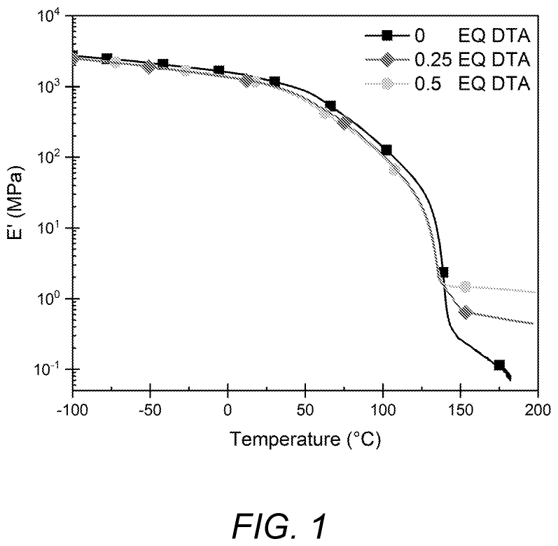

PE-MAH cross-linked with DTA—Example 1 DMTA measurements. The HDPE-MAH with 0 EQ. (square moniker), 0.25 EQ. (diamond moniker), and 0.5 EQ. (circle monikers) of DTA are shown in FIG. 1. The vitrimers that included the DTA retained a modulus after melting, revealing the characteristic rubber plateau for such semi-crystalline vitrimers. Such a rubbery plateau was not present in the pristine HDPE-MAH material (0 EQ). The rubber plateau was found to increase with increasing amount of DTA cross-linker due to the increased cross-link density.

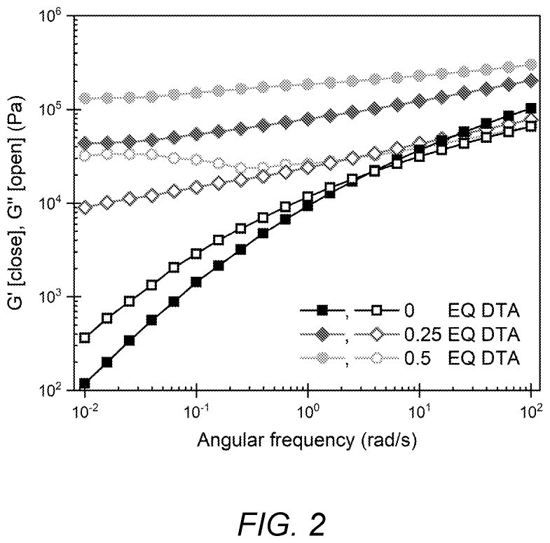

Frequency sweep measurements for Example 1 samples are shown in FIG. 2. The curve of the sample denoted as pristine polymer corresponded to the pristine HDPE-MAH polymer with 0.4 mol % of MAH (square monikers open and closed) and showed a clear frequency dependent flow behavior of a standard polymer melt with a crossover frequency where G′(open)=G″(closed). On the contrary, the cross-linked vitrimer material having 0.5 EQ of DTA (circle monikers, open and closed) revealed properties of a cross-linked rubber with an almost frequency independent G′ and a solid like character (G′>G″) over the entire measurement range. This shows the successful cross-linking via DTA.

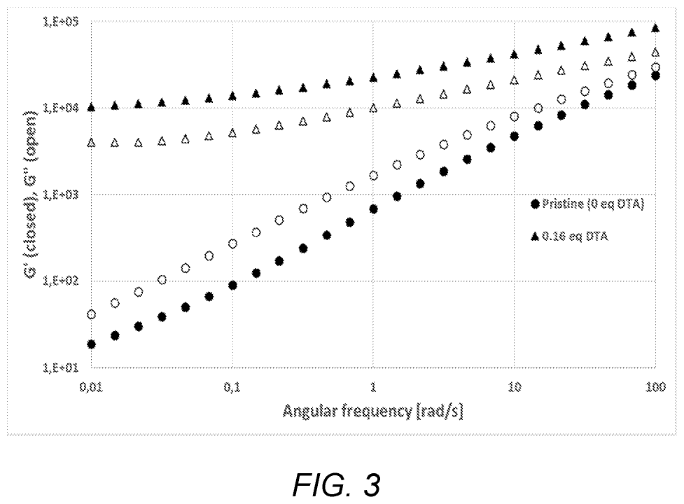

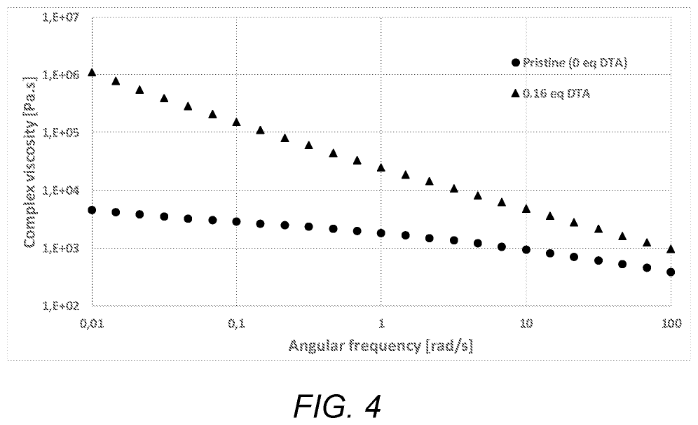

Similar results were obtained for Example 2 samples prepared via extrusion for which frequency sweep measurements were performed at 210° C. A clear difference in flow behavior between the pristine PO-MAH samples and the cross-linked samples was observed. As an example, the results of the LLDPE-based samples are shown in FIG. 3 and discussed here. The LLDPE-MAH containing material (Example 2-2-0) showed a clear frequency dependent flow behavior of a standard polymer melt with G″>G′ (circle monikers, opened and closed). On the contrary, the cross-linked vitrimer material (LLDPE-MAH+DTA, triangle monikers, opened and closed, Example 2-2-1) revealed properties of a cross-linked rubber with an almost frequency independent G′ and a solid like character (G′>G″) over the entire measurement range. This indicated the successful cross-linking via DTA. The complex viscosity as shown in FIG. 4 of the LLDPE-MAH was also influenced by the introduction of cross-links. The presence of the cross-links resulted in a disappearance of the Newtonian plateau at low frequencies (typical behavior for thermoplastic polymer melts) as the viscosity linearly increases with decreasing frequency.

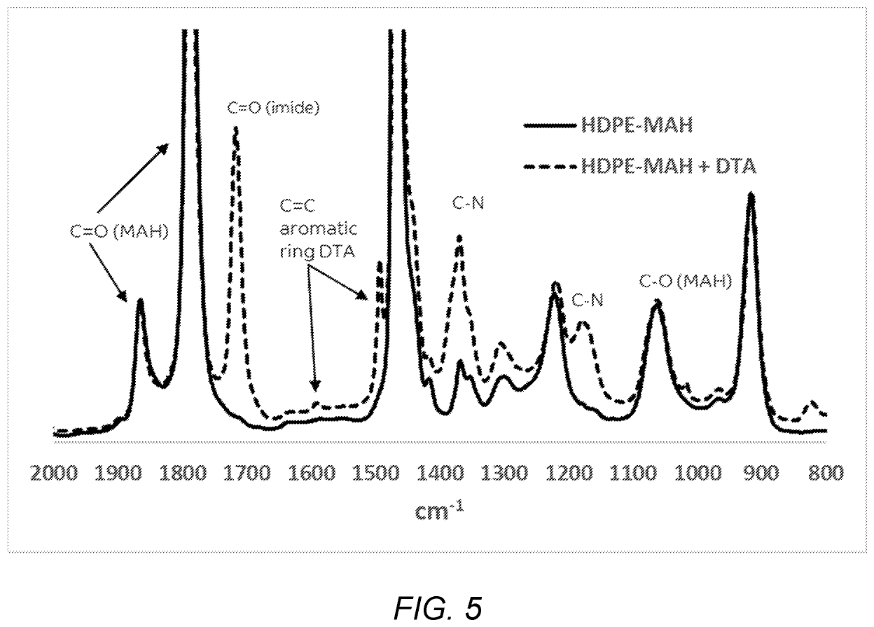

FTIR-measurements were performed to confirm that the reaction occurred between the MAH-group and the NH₂-group of the DTA-cross-linker. FIG. 5 shows the FTIR spectra overlays of the HDPE-MAH and HDPE-MAH+DTA. The appearance of specific signals showed that DTA had reacted with the MAH-groups: a peak at 1717 cm⁻¹ representing a C═O signal of the imide ring, a more intense signal at 1369 cm⁻¹ representing a signal of the C—N of the imide ring (combined with a CH-signal), the peak at 1590 and 1493 cm⁻¹ for the aromatic ring, the peak at 1178 cm⁻¹ for the C—N of the imide ring. In addition, there was no signal found in the 3500-3000 cm⁻¹ range, indicating that there are no NH₂ or NH-groups present. Similar FTIR-results were obtained for the other samples mentioned in Table 2.

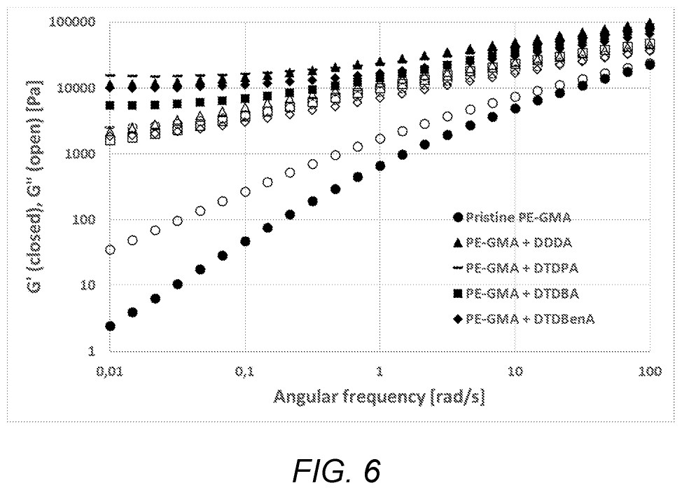

Frequency sweep measurements of PE-GMA crosslinked with several dithio-containing diacids from Example 3 are shown in FIG. 6. A clear difference in curves was observed between the pristine PE-GMA sample and the cross-linked samples. The PE-GMA-sample showed a clear frequency dependent flow behavior of a standard polymer melt with G″>G′ (FIG. 6). On the contrary, the cross-linked vitrimer materials obtained with 0.05 equivalents of different diacids reveal properties of a cross-linked rubber with an almost frequency independent G′ and a solid like character (G′>G″) over the entire measurement range. This indicates the successful reaction between the epoxy-group of the GMA-unit and the acid-groups of the cross-linking agent.

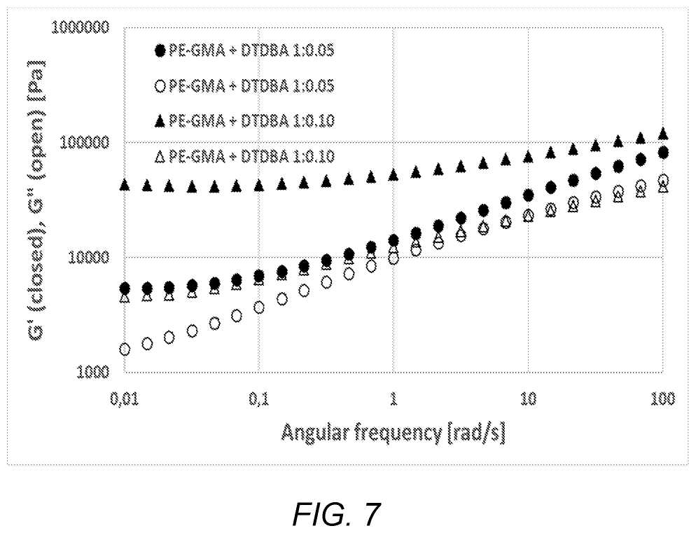

FIG. 7 shows the G′- and G″-values for two PE-GMA-based materials cross-linked with different loading of DTDBA (4,4′-dithiodibutyric acid) as described in Example 3. As shown, a higher loading of the cross-linker (triangle monikers, opened and closed) resulted in a material having the characteristic of a more cross-linked rubber, with an almost frequency independent G′ and a solid like character (G′>G″) over the entire measurement range.

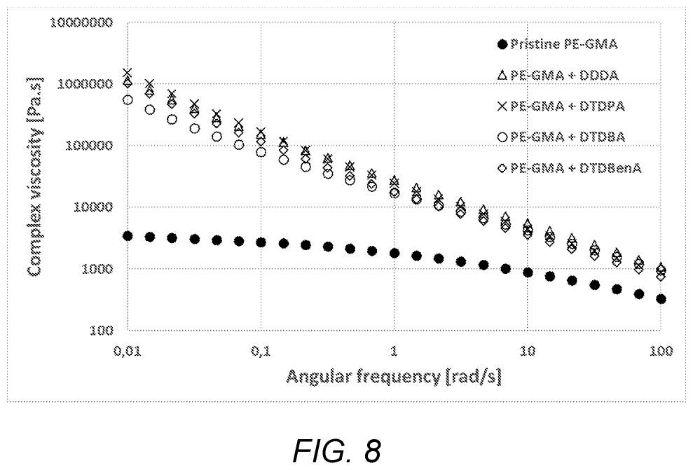

FIG. 8 shows the complex viscosity of the PE-GMA based materials of Example 3. The complex viscosity of the PE-GMA was also largely influenced by the introduction of cross-linking material of the present invention. The presence of the cross-links results in a disappearance of the Newtonian plateau at low frequencies (typical behavior for thermoplastic polymer melts) as the viscosity linearly increases with decreasing frequency.

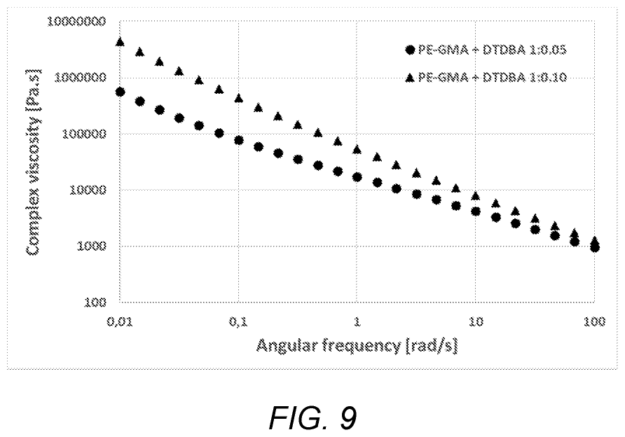

FIG. 9 shows the complex viscosities for two PE-GMA-based materials cross-linked with different loadings of DTDBA. As shown, a higher loading of the cross-linker (triangle monikers) resulted in a material having a viscosity that linearly increased with decreasing frequency.

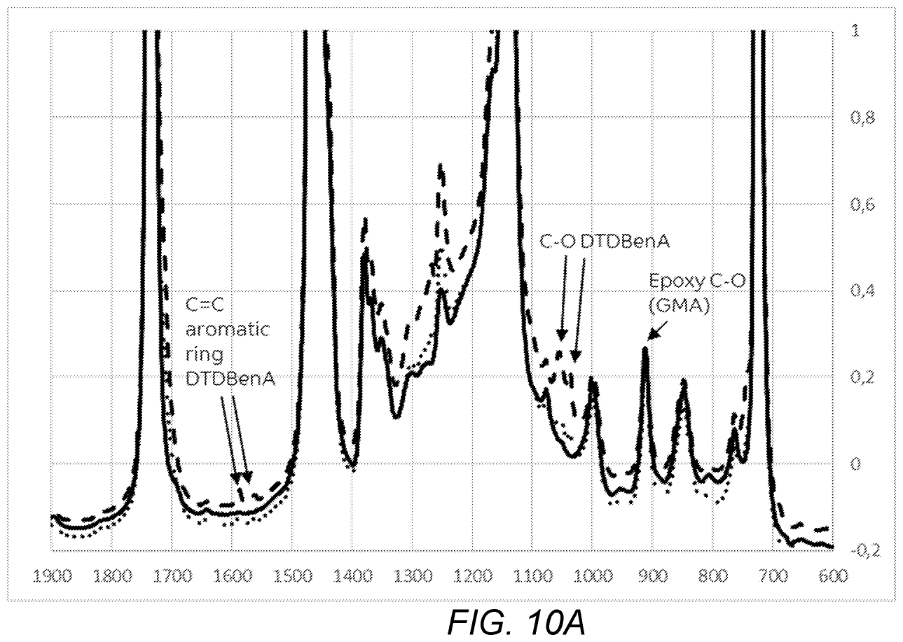

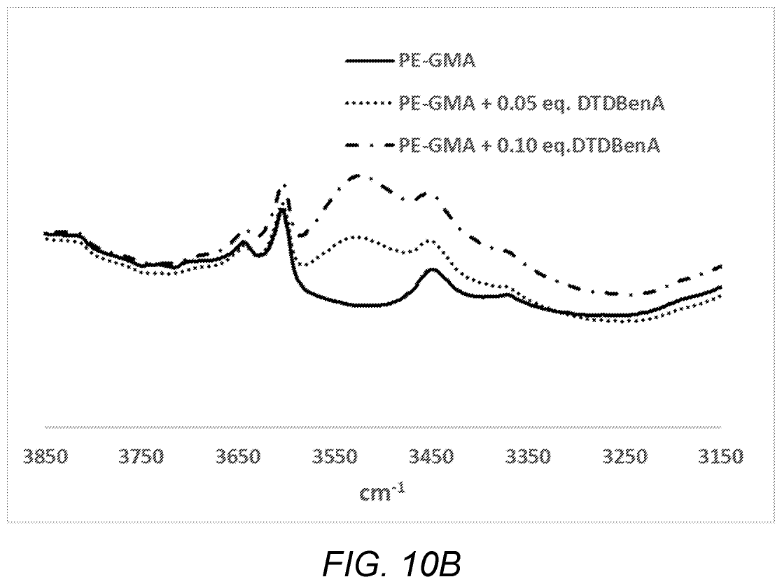

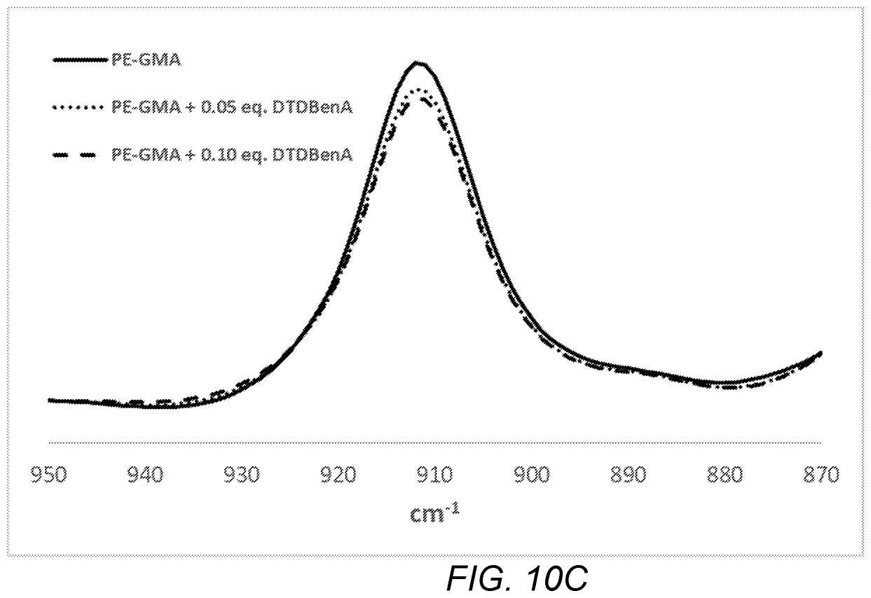

The reaction of the epoxy groups of the GMA-units and the acid-groups of the cross-linking agents was confirmed by results obtained from FTIR-measurements. FIGS. 10A-10C shows the comparison of the spectra of pristine PE-GMA and PE-GMA reacted with 0.5 and 0.10 equivalents of DTDBenA. The appearance of a significant signal at 3527 cm⁻¹ was attributed to the presence of an OH-group, a result of the reaction of the epoxy group and an acid group (FIG. 10B). Another indication that the reaction took place was seen in the decrease of the area under the peak at 912 cm⁻¹ (FIG. 10C), the signal of an epoxy group, with increasing loadings of the di-acid DTDBenA. Similar FTIR-results were obtained for the reaction products of PE-GMA with the other di-acids, being DDDA, DTDPA and DTDBA.

The effect of the dynamic disulfides was not obvious from the G′, G″ and complex viscosity data obtained from the frequency sweeps, as the materials have a similar amount of cross-links as the cross-linked PE-GMA material obtained via reaction with DDDA. However, this effect was obvious when the stress relaxation data was compared. Table 4 lists the relaxation times needed to relax the stress to 36.8% of the stress determined at the moment the applied strain reached 1%. The relaxation of stress was very fast in PE-GMA, as the only restriction is disentanglement of polymer chains and declustering of agglomerates of epoxy-groups. The formation of cross-links via reaction of the epoxy groups with acid groups of DDDA resulted in a permanent network that relaxed the strain very slowly. It was clear that the PE-GMA-based vitrimers that contained disulfide moieties in their structure relaxed the stress much faster than the PE-GMA-based material having a permanent aliphatic cross-link obtained via DDDA. This faster relaxation was contributed to disulfide exchange reactions.

TABLE 4

| | | PE-GMA + DTDBA | PE-GMA + DTDBenA | PE-GMA + DTDPA | PE-GMA + DDDA |
|---|---|---|---|---|---|
| | PE-GMA | 1:0.05 | 1:0.05 | 1:0.05 | 1:0.05 |
| Relaxation | 0.5 s | 1.4 s | 3.6 s | 3.0 s | 11500 s |
| time | | | | | |

### Example 6

### Adaptability of Polyolefin Based Vitrimers of the Present Invention

Adaptability of PO-based vitrimeric systems of the present invention was apparent from being able to compression mold defect free circular and rectangular disks and by the ability to reprocess these disks as necessary.

### Example 7

### Preparation of Polyolefin (PO)-MAH Disulfide Vitrimers Using Dry Blend Mixing Followed By Melt Extrusion

A dry blend of maleic anhydride (MAH) functionalized polyolefin (PO-MAH) polymer powder and 4,4′-dithiodianiline (DTA) was prepared by mixing the desired amount of PO-MAH polymer powder and a molar equivalent amount of the dithio moiety (with respect to MAH-groups). Powder blends of 250 gram were prepared this way, and thereafter fed into the hopper of a Thermofisher P11 twin screw extruder. A throughput of 150 gr/hr and a screw speed of 100 rpm was used to process these powder blends at a set temperature of 230° C. The extruded strand that exited the die of the extruders, was led through a water batch and then pelletized into granules. Compression molding was used to prepare discs and plates that were used for rheology and mechanical testing. Table 5 lists an overview of PO-MAH-based materials and dithio moieties.

TABLE 5

| | MAH (wt. % | mmol MAH (in 250 | molar equivalent |
|---|---|---|---|
| Polymer | in polymer) | gr polymer) | of DTA |
| LLDPE-0.3MAH | 0.3 | 5.95 | 0.25 |
| | | | 0.50 |
| LLDPE-0.6MAH | 0.6 | 11.9 | 0.25 |
| | | | 0.50 |

### Example 8

### Analysis of Examples 7 Vitrimers

### I. Testing Methodology:

Dynamic Mechanical Thermal Analysis (DMTA) Measurements. Rectangular samples suitable for DMTA were cut to dimension of 15×5.5×1 mm (length×width×thickness) from a film that was obtained via compression molding. Samples were measured on a TA Instruments Q800 in tensile mode. The storage modulus (E′) and loss modulus (E″) were monitored while screening the samples during a temperature sweep from −100 to 200° C. at 3° K/min. A strain of 0.1% was applied to the samples at an oscillation frequency of 10 Hz.

Rheology measurements. Samples for rheology were prepared via compression molding to obtain disk shaped specimens (diameter 25 mm, thickness 1 mm). Samples were measured using an Anton Paar MCR502, equipped with a parallel plate geometry. Frequency sweep measurements were made in the frequency range from 100-0.01 rad/s using a strain amplitude of 1% at a temperature of 210° C. Stress relaxation measurements were conducted at 210° C. by applying a constant shear strain of 1%.

Tensile testing. Tensile bars (mini dog-bones; 100×5×1 mm) were obtained from compression molded plates (100×100×1 mm) using a die cutting tool. The samples were tested with a Zwick Roel Z010 testing machine with a fixed crosshead speed of 50 mm/min according to the ISO 527-1 Testing protocol.

### II. Results:

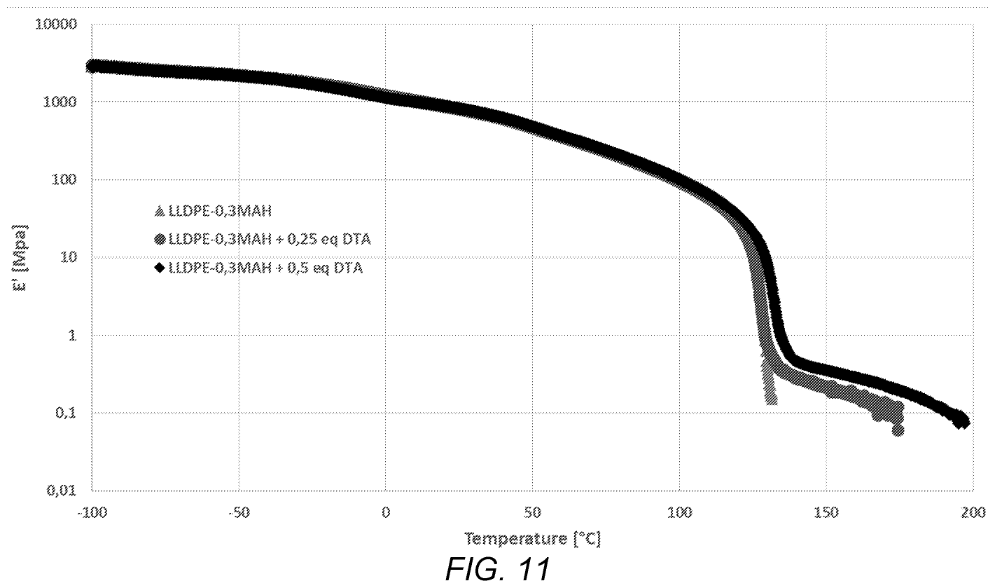

DMTA measurements. The LLDPE-0.3MAH with 0 EQ. (black line), 0.25 EQ. (dark grey line), and 0.5 EQ. (light grey line) of DTA are shown in FIG. 11. The vitrimers that included the DTA retained a modulus after melting, revealing the characteristic rubber plateau for such semi-crystalline vitrimers. Such a rubbery plateau was not present in the pristine LLDPE-0.3MAH material (0 EQ). The rubber plateau was found to increase with increasing amount of DTA cross-linker due to the increased cross-link density.

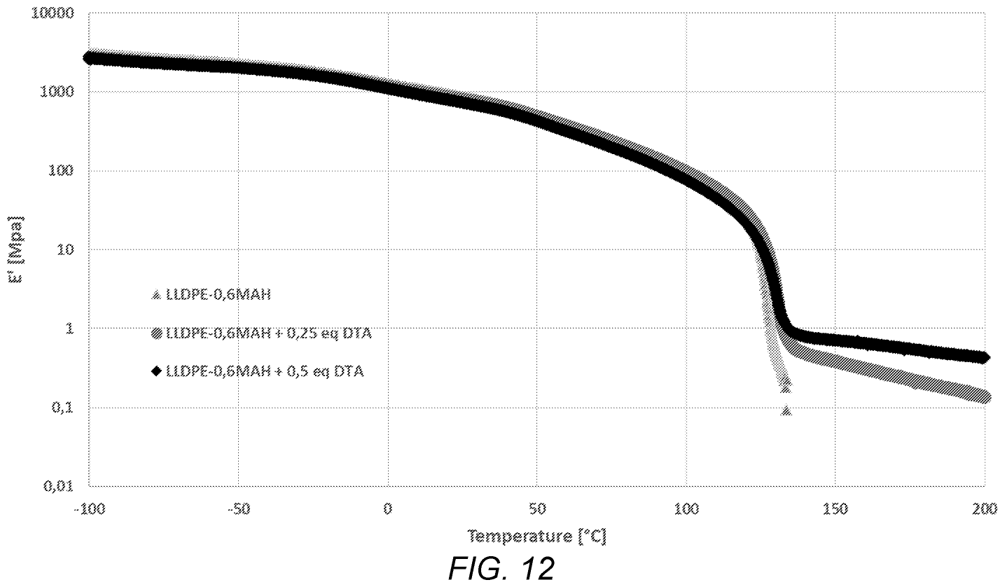

The LLDPE-0.6MAH with 0 EQ. (black line), 0.25 EQ. (dark grey line), and 0.5 EQ. (light grey line) of DTA are shown in FIG. 12. The vitrimers that included the DTA retained a modulus after melting, revealing the characteristic rubber plateau for such semi-crystalline vitrimers. Such a rubbery plateau was not present in the pristine LLDPE-0.6MAH material (0 EQ). The rubber plateau was found to increase with increasing amount of DTA cross-linker due to the increased cross-link density. When comparing FIGS. 11 and 12, it is clear that a higher level of MAH units leads to a higher level of cross-links, resulting in a higher modulus at temperatures above the melting point.

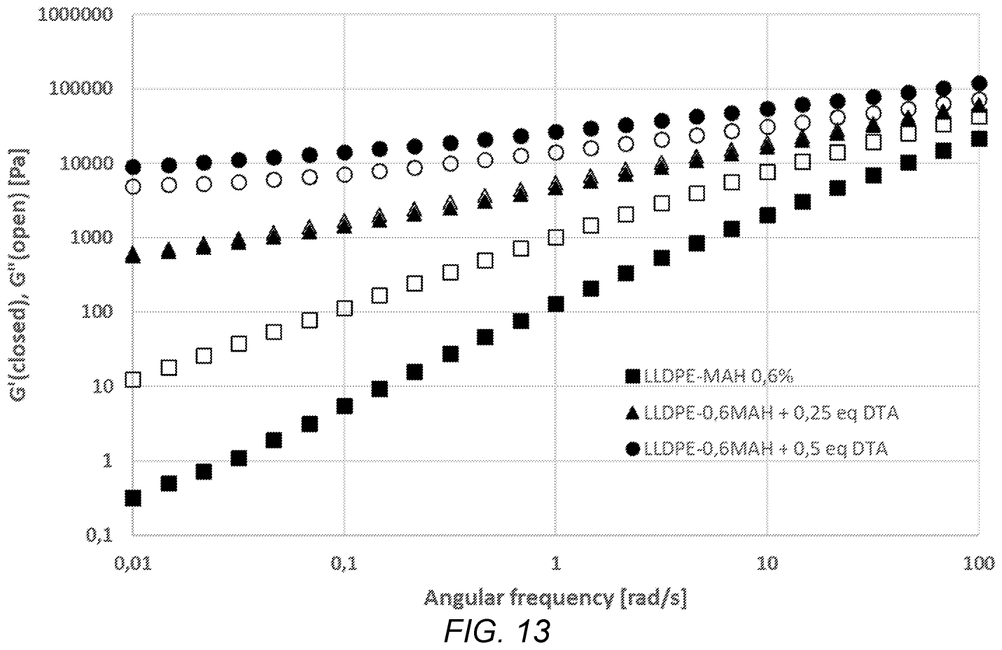

Frequency sweep measurements for samples containing 0.6% MAH-units are shown in FIG. 13. The curve of the sample denoted as pristine polymer corresponded to the pristine LLDPE-0.6MAH polymer with 0.6 wt. % of MAH (square monikers open and closed) and showed a clear frequency dependent flow behavior of a standard polymer melt with a crossover frequency where G′(open)=G″(closed). On the contrary, the cross-linked vitrimer material having 0.25 EQ of DTA (triangle monikers, open and closed) shows almost equal values for G′ and G″ over the entire frequency range, indicating that the material has become more elastic due to the presence of cross-links. The cross-linked vitrimer material having 0.5 EQ of DTA (circle monikers, open and closed) revealed properties of a cross-linked rubber with an almost frequency independent G′ and a solid like character (G′>G″) over the entire measurement range. This shows the successful cross-linking via DTA.

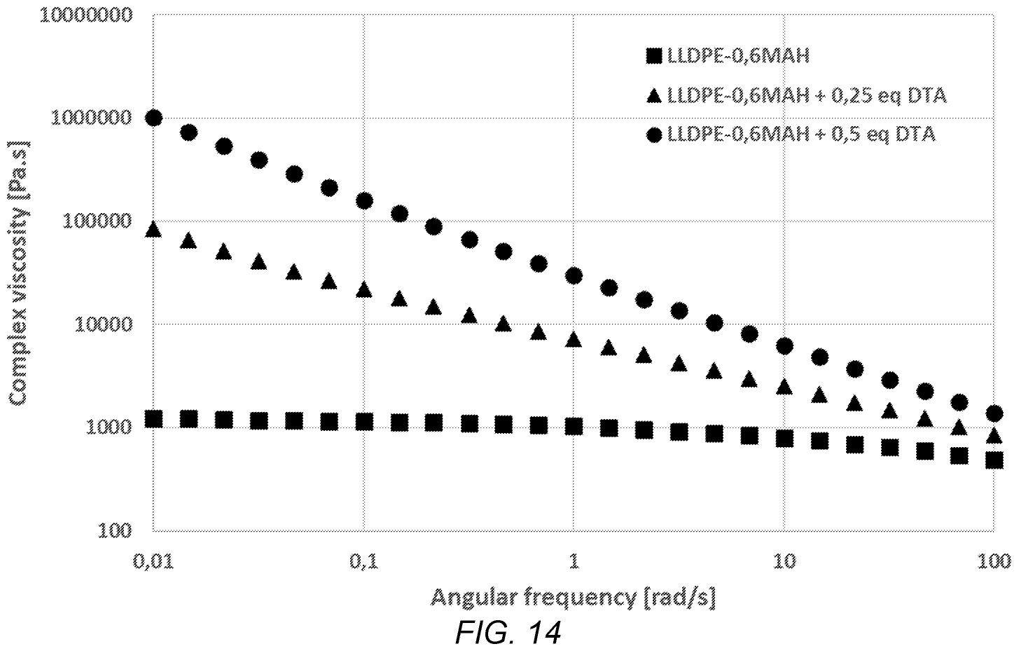

The complex viscosity as shown in FIG. 14 of the LLDPE-0.6 MAH (square monikers) was also influenced by the introduction of cross-links. The presence of the cross-links resulted in a disappearance of the Newtonian plateau at low frequencies (typical behavior for thermoplastic polymer melts) as the viscosity linearly increases with decreasing frequency.

The values of the tensile stress and elongation at yield and break as determined by tensile testing are listed in Table 6 for the pristine MAH-functionalized LLDPE and those cross-linked with 0.25 eq and 0.5 eq DTA. The listed values are the average of 5 samples, and the standard deviation is shown in brackets. The presence of the cross-links results in a slight lowering of the modulus and a slight increase of the stress at break.

TABLE 6

| Sample | Eₜ (MPa) | σ_{Y} [MPa] | ε_{Y} [%] | σ_{B} [MPa] | ε_{B} [%] |
|---|---|---|---|---|---|
| LLDPE-0.3MAH | 291.9 (80.6) | 14.1 (0.7) | 10.2 (0.9) | 14.7 (3.0) | 754.6 (97.4) |
| LLDPE-0.3MAH + | 288.1 (113.0) | 13.1 (0.5) | 12.5 (0.4) | 17.1 (2.3) | 797.3 (130.8) |
| 0.25 eq DTA | | | | | |
| LLDPE-0.3MAH + | 218.0 (88.6) | 14.2 (0.1) | 12.56 (0.2) | 19.5 (1.7) | 728.5 (61.3) |
| 0.50 eq DTA | | | | | |
| LLDPE-MAH 0.6% | 391.3 (68.6) | 13.0 (0.7) | 12.0 (0.4) | 14.4 (1.2) | 695.7 (73.9) |
| LLDPE-0.6MAH + | 351.2 (109.1) | 14.3 (0.3) | 11.7 (0.4) | 19.7 (0.4) | 727.3 (27.5) |
| 0.25 eq DTA | | | | | |
| LLDPE-0.6MAH + | 317.8 (197.2) | 14.6 (0.3) | 12.5 (0.7) | 20.1 (1.1) | 615.8 (39.0) |
| 0.50 eq DTA | | | | | |

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A vitrimer material having a formula of A-L-A′, wherein A and A′ are each independently a functionalized polymeric unit and L is a linking unit comprising at least two sulfur (S) atoms and having a formula of R¹—S¹—(S³)ₙ—S²—R² where n is 0 to 3 and R¹ and R² are each independently a substituted aliphatic group, or a substituted aromatic group, and R¹ and R² are each independently bonded to A or A′; wherein the vitrimer material has a semi-crystalline morphology;
wherein the functionalized polymeric unit comprises an anhydride or an ethylenically unsaturated oxirane.

2. The vitrimer material of claim 1, wherein the S¹ atom is bonded to a carbon atom of the R¹ group and the S² atom is bonded to a carbon atom of the R² group.

3. The vitrimer material of claim 1, wherein n is 0.

4. The vitrimer material of claim 1, wherein R¹ and R² are each independently a substituted aromatic group.

5. The vitrimer material of claim 4, wherein R¹ and R² are both an aniline group, and the vitrimer material has the structure of: 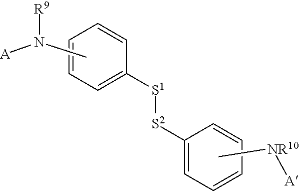
where A and A′ can be the same or different functionalized polymeric units, R⁹ and R¹⁰ can each independently be a H, an alkyl group, or R⁹ can come together with functional group of A and form a ring, and R¹⁰ can come together with functional group of A′ and form a ring.

6. The vitrimer material of claim 4, wherein R¹ and R² are both a benzoether group, and the vitrimer material has the structure of:

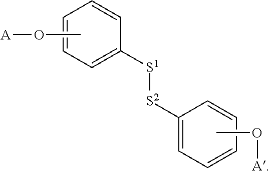

7. The vitrimer material of claim 4, wherein R¹ and R² are both a benzoester group, and the vitrimer material has the structure of:

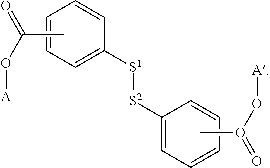

8. The vitrimer material of claim 1, wherein R¹ and R² are each independently a substituted aliphatic group.

9. The vitrimer material of claim 8, wherein the substituted aliphatic group comprises a carboxylic acid group.

10. The vitrimer material of claim 9, wherein the vitrimer has the structure of: 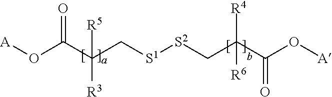
where a is 0 to 10 and b is 0 to 10, R³, R⁴, R⁵, and R⁶ are each independently a hydrogen atom (H), an aliphatic group, a substituted aliphatic group, an aromatic group, a substituted aromatic group, or a heteroatom or a combination thereof, and A and A′ represent the functionalized polymeric units.

11. The vitrimer material of claim 10, wherein the vitrimer has the structure of: 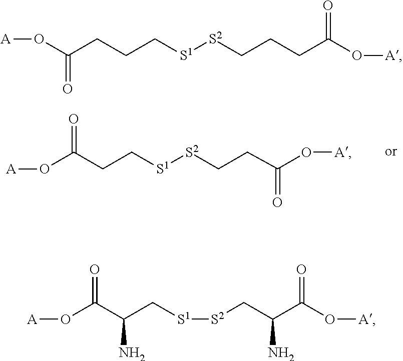
where A represents the polymeric unit.

12. The vitrimer material of claim 8, wherein the substituted aliphatic group comprises a hydroxyl group and/or the vitrimer has the structure of: 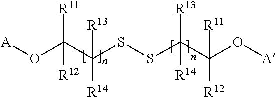
where R¹¹, R¹², R¹³, and R¹⁴ can each independently be a hydrogen atom (H), or a C₁ to C₁₀ aliphatic group, a substituted C₁ to C₁₀ aliphatic group, a C₆ to C₂₀ aromatic group, a substituted C₆ to C₂₀ aromatic group, or a heteroatom or a combination thereof, and n can be 0 to 20, and A and A′ represent the functionalized polymeric units.

13. The vitrimer of claim 12, wherein the vitrimer has the structure of 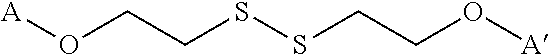
where A and A′ represent the functionalized polymeric units.

14. The vitrimer of claim 1, wherein the polymeric unit A, A′, or both are derived from a maleic anhydride-functionalized polyolefin based polymer or a glycidyl methacrylate-functionalized polyolefin based polymer.

15. An article of manufacture comprising the vitrimer of claim 1.

16. The article of claim 15, wherein said article comprises a solid component, a polymeric material, a film, a sheet, or a foam.

17. (canceled)

18. A process of producing the vitrimer material of claim 1, the process comprising extruding a reactant mixture at a temperature of 120° C. to 300° C., wherein the reactant mixture comprises a functionalized polyolefin composition and a linking material having a formula of R¹—S—(S)ₙ—S—R² where n is 0 to 3 and R¹ and R² are each independently a substituted aliphatic group, or a substituted aromatic group, or a combination thereof.

19. The process of claim 18, wherein the functionalized polyolefin composition comprises a maleic anhydride-functionalized polyolefin, a glycidyl methacrylate-functionalized polyolefin, or both.

20. The process of claim 18, wherein the linking material comprises an terminal amino group, a terminal carboxylic group, a terminal hydroxyl group, an ether terminal group, an amide terminal group or an imide terminal group or a mixture thereof.

21. The process of claim 18, wherein the level of functionalization is 0.1 to 10 wt %.
